(19) United States
(12) Patent Application Publication
(10) Pub. No.: US 2019/0174803 A1
(43) Pub. Date: Jun. 13, 2019

(54) CHELATING AGENTS FOR REDUCING METAL CONTENT IN FOOD PRODUCTS AND METHODS RELATED THERETO

(71) Applicant: Axiom Foods, Inc., Los Angeles, CA (US)

(72) Inventor: Robert E. Cadwalader, Glen Ellyn, IL (US)

(21) Appl. No.: 16/275,114

(22) Filed: Feb. 13, 2019

Related U.S. Application Data
(63) Continuation of application No. PCT/US2017/047184, filed on Aug. 16, 2017.
(60) Provisional application No. 62/376,716, filed on Aug. 18, 2016.

(51) Int. Cl. A23L 5/20; A23J 3/34

(52) U.S. Cl. CPC A23L 5/273; A23V 2002/00; A23J 3/346

(57) ABSTRACT

Some embodiments relate to metal chelators for preparing food products (including nutritional supplements) from vegetable and plant sources having reduced metal content. In some embodiments, the plant sources include rice. In some embodiments, when complexed to a metal to be removed, the metal chelators are water soluble and can be separated (e.g., rinsed, etc.) from the food material during processing. In some embodiments, the metal chelators are organic certifiable.

### CROSS-REFERENCE TO RELATED APPLICATIONS

This patent application is a continuation of International PCT Application No. PCT/US2017/047184, filed Aug. 16, 2017, which claims the benefit of priority to U.S. Provisional Patent Application No. 62/376,716, filed Aug. 18, 2016. The foregoing applications are fully incorporated herein by reference in their entireties for all purposes.

### BACKGROUND

### Field of the Invention

Disclosed herein are chelators for removing metals from food products and methods of use thereof.

### Description of the Related Art

When concentrating and isolating vegetable and plant products, large bulk amounts of material are often isolated and concentrated to afford final products. During this isolation process, heavy metals present in only small amounts of the bulk source can become more concentrated and can reach unacceptably high concentrations.

### SUMMARY

Some embodiments, pertain to a method for preparing an organic food product with reduced heavy metal. In some embodiments, the method comprises adding an organic certified or organic certifiable chelator to an organic food product that contains a heavy metal. In some embodiments, the method comprises allowing the chelator to bind to the heavy metal thereby forming a complex. In some embodiments, the method comprises separating the complex from the food product to prepare the organic food product with reduced heavy metal content.

Any of the methods described above, or described elsewhere herein, can include one or more of the following features.

In some embodiments, the organic certified or organic certifiable chelator is a peptide chelator, citric acid, or salts thereof. In some embodiments, the food product is a macronutrient isolate. In some embodiments, the macronutrient isolate is a carbohydrate isolate, a fat isolate, or a protein isolate. In some embodiments, the macronutrient is derived from a plant. In some embodiments, the food product is derived from white rice, brown rice, rice bran, flaxseed, coconut, pumpkin, hemp, pea, chia, lentil, fava, potato, sunflower, quinoa, amaranth, oat, wheat, or combinations thereof. In some embodiments, the food product is a plant protein.

In some embodiments, the heavy metal is arsenic, cadmium, lead, mercury, or combinations thereof.

In some embodiments, the separating step is performed by filtration through a filter. In some embodiments, the complex is substantially soluble and travels through the filter. In some embodiments, the separating step is performed by decanting and/or centrifugation.

In some embodiments, the chelator is a peptide chelator, wherein the peptide chelator is prepared by hydrolyzing an organic protein. In some embodiments, the peptide chelator is prepared by enzymatic or chemical hydrolysis of the organic protein. In some embodiments, the organic protein is derived from the same plant or animal as the food product.

Some embodiments pertain to a composition comprising a rice protein isolate. In some embodiments, the rice protein isolate comprises a heavy metal bound to an organic certified or organic certifiable chelator. In some embodiments, the organic certified or organic certifiable chelator is a peptide chelator or citric acid. In some embodiments, the peptide chelator is a rice protein hydrolysate. In some embodiments, the protein isolate is an intermediate in the production of a nutritional supplement. In some embodiments, the intermediate comprises a rice protein isolate comprising a heavy metal bound to an organic certified or organic certifiable chelator.

Some embodiments pertain to a method for preparing a peptide chelator. In some embodiments, the method comprises enzymatically or chemically hydrolyzing an organic protein to form an organic peptide chelator. In some embodiments, the method comprises collecting the peptide chelator. In some embodiments, the organic protein is hydrolyzed enzymatically using an enzyme.

In some embodiments, the enzyme comprises one or more of an acid endopeptidase, an alkaline endopeptidase, pepsin, papain, carboxypeptidase, trypsin, chymotrypsin, or thermolysin.

In some embodiments, the method comprises fractionating the peptide chelator from the hydrolysate.

Some embodiments pertain to a peptide chelator. In some embodiments, the peptide chelator comprises dominant (e.g., higher than average intensity and/or darker than average) bands from a PAGE gel (and/or peaks from an optical intensity scan of those bands) at molecular weights ranging from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the dominant PAGE bands (and/or peaks taken from the gel scan) of the peptide chelator are at one or more of about 20.5 kD, about 15 kD, and/or about 12.7 kD. In some embodiments, the dominant bands and/or peaks of the peptide chelators are at one or more of about 20.5 kD, about 15 kD, about 12.7 kD, and/or about 11 kD.

Some embodiments, pertain to a method of making a peptide chelator. In some embodiments, the method includes a step of exposing a protein from a plant source to hydrolytic conditions for a period of time to prepare the protein chelator. In some embodiments, the method includes a step of removing the protein chelator from the hydrolytic conditions. In some embodiments, the method includes a step of collecting the protein chelator.

In some embodiments, the period of time is less than or equal to about 1 hour, about 2 hours, about 4 hours, about 6 hours, or ranges including and/or spanning the aforementioned values.

In some embodiments, during exposure to the hydrolytic conditions, the protein is exposed to an enzyme.

In some embodiments, during collecting of the peptide chelator, the peptide chelator is filtered to isolate the peptide chelator based on size and/or molecular weight.

In some embodiments, the peptide chelator prepared by the methods disclosed herein has dominant bands (e.g., peaks) from a PAGE gel at molecular weight ranges from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the peptide chelator prepared by the methods disclosed herein has its dominant PAGE bands and/or peaks at one or more of about 20.5 kD, about 15 kD, and/or about 12.7 kD. In some embodiments, the peptide chelator prepared by the methods disclosed herein has its dominant PAGE bands (e.g., peaks) at one or more of about 20.5 kD, about 15 kD, about 12.7 kD, and/or about 11 kD.

Some embodiments pertain to peptide chelator, comprising a protein hydrolysate comprising one or more peptides that range in molecular weight from about 2 kD to about 25 kD. In some embodiments, the one or more peptides have molecular weight ranges selected from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the one or more peptides comprise molecular weights selected from about 20.5 kD, about 15 kD, and about 12.7 kD. In some embodiments, the one or more peptides comprise molecular weights selected from about 20.5 kD, about 15 kD, about 12.7 kD, and about 11 kD.

Some embodiments pertain to a peptide chelator made by a method comprising exposing a protein from a plant source to hydrolytic conditions for a period of time to prepare the protein chelator. In some embodiments, the method comprises removing the protein chelator from the hydrolytic conditions. In some embodiments, the method comprises collecting the protein chelator. In some embodiments, the period of time in hydrolytic conditions is less than or equal to about 1 hour, about 2 hours, about 4 hours, about 6 hours, or ranges including and/or spanning the aforementioned values. In some embodiments, exposure to the hydrolytic conditions, the protein is exposed to an enzyme. In some embodiments, during collecting of the peptide chelator, the peptide chelator is filtered to collect the peptide chelator based on size and/or molecular weight. In some embodiments, the method results in a peptide chelator that comprises one or more peptides having molecular weight ranges selected from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the method results in a peptide chelator that comprises one of more peptides that comprise molecular weights selected from about 20.5 kD, about 15 kD, and/or about 12.7 kD. In some embodiments, the method results in a peptide chelator that comprises one of more peptides that comprise molecular weights selected from about 20.5 kD, about 15 kD, about 12.7 kD, and/or about 11 kD.

### BRIEF DESCRIPTION OF THE DRAWINGS

FIG. 1 depicts data quantifying metal content in a variety of rice types and rice from various sources.

FIG. 2A provides an overview of the total % reduction of heavy metals from protein mixtures at different pH values using a various chelators or water.

FIG. 2B depicts results for the reduction of heavy metals from protein mixtures at pH 3 using various chelators or water.

FIG. 2C depicts results for the reduction of heavy metals from protein mixtures at pH 6 using various chelators or water.

FIG. 2D depicts results for the reduction of heavy metals from protein mixtures at pH 9 using various chelators or water.

FIG. 2E depicts results for the reduction of arsenic from protein mixtures at different pH values using various chelators or water.

FIG. 2F depicts results for the reduction of cadmium from protein mixtures at different pH values using various chelators or water.

FIG. 2G depicts results for the reduction of lead from protein mixtures at different pH values using various chelators or water.

FIG. 2H depicts results for the reduction of mercury from protein mixtures at different pH values using various chelators or water.

FIG. 2I depicts results for the reduction of arsenic from protein mixtures at different pH values using various chelators or water.

FIG. 2J depicts results for the reduction of cadmium from protein mixtures at different pH values using various chelators or water.

FIG. 2K depicts results for the reduction of lead from protein mixtures at different pH values using various chelators or water.

FIG. 2L depicts results for the reduction of mercury from protein mixtures at different pH values using various chelators or water.

FIGS. 3A-3B depict the results of water rinses to remove arsenic from protein mixtures at different pH values.

FIGS. 3C-3D depict the results of water rinses to remove cadmium from protein mixtures at different pH values.

FIGS. 3E-3F depict the results of water rinses to remove mercury from protein mixtures at different pH values.

FIGS. 3G-3H depict the results of water rinses to remove lead from protein mixtures at different pH values.

FIG. 4A is an image of a polyacrylamide gel electrophoresis (“PAGE”) peptide separation gel (coomassie blue-stained).

FIGS. 4B-4F are scans showing the molecular weight distribution of the tracks from the FIG. 4A PAGE gel.

### DETAILED DESCRIPTION

Some embodiments disclosed herein pertain to chelators, methods of making and/or using chelators, and/or methods for reducing and/or removing metals from food products. In some embodiments, the metals are heavy metals. In some embodiments, the food product is a grain or vegetable isolate. In some embodiments, food products include one or more of carbohydrate-based isolates (including starch, cellulose, bran, fiber, carbohydrates, saccharides, polysaccharides, oligosaccharides, maltodextrin, etc.), protein-based isolates, (including amino acids, peptides, oligopeptides, proteins, etc.), fat-based isolates (e.g., oils, fat, etc.), minerals and/or combinations thereof isolated from a variety of sources. In some embodiments, the food products include matter derived from rice, rice bran, flaxseed, coconut, pumpkin, hemp, pea, chia, lentil, fava, potato, sunflower, quinoa, amaranth, oat, wheat, and the like. In some embodiments, the food product is a grain or vegetable protein isolate. In some embodiments, food products include matter isolated from plants (e.g., plant matter that is one or more of carbohydrate-based, protein-based, fat-based, and/or mineral containing) and/or animal material (e.g., animal material that is protein-based, fat-based, and/or mineral containing). In some embodiments, the food product is organic (e.g., organic-certified or certifiable under U.S., European, or Japanese organic certification standards). In some embodiments, a chelator is employed during the isolation of protein, carbohydrate, or fat from the protein source. In some embodiments, the chelator is employed after the isolate (e.g., the protein, carbohydrate, fat, or combinations thereof) has been isolated. For example, products can be submitted to metal reducing conditions for metal remediation. In some embodiments, for example, the protein, fat, or carbohydrate, for example, is reprocessed with the chelator to remove metals. In some embodiments, the chelator is also organic, organic-certified, and/or organic certifiable.

In some embodiments, the metal-reduction processes disclosed herein can be done using any one or more of the chelators disclosed herein (alone or in combination) or with other chelators that accomplish the objective of preparing organic or organic certifiable foods with substantially removed or reduced heavy metal content. In some embodiments, any one of the steps of the methods disclosed herein can be combined and/or omitted.

Because of potential health risks and/or potential dangers associated with consuming chemically treated food, there is a growing demand for organic food. In the United States, there are currently four different levels or categories for organic labeling: 1) ‘100%’ Organic (all ingredients are produced organically); 2) ‘Organic’ (at least 95% or more of the ingredients are organic); 3) ‘Made With Organic Ingredients’ (contains at least 70% organic ingredients); and 4) ‘Less Than 70% Organic Ingredients’ (where three of the organic ingredients must be listed under the ingredient section of the label). Foods that are organically prepared must be free of artificial food additives, and are often processed with fewer artificial methods, materials and conditions, such as chemical ripening, food irradiation, and genetically modified ingredients. Non-synthetic pesticides (e.g., naturally occurring) or treatments are allowed but synthetic ones generally are not.

While consuming organic processed foods is considered healthier than consuming non-organic processed foods, some processed foods, even if organic, can contain harmful agents. For example, despite potential health benefits of organic processed foods, heavy metals may be present in them (just as in non-organic processed foods). These metals can be naturally present in food or can enter food as a result of human activities (such as industrial and agricultural processes).

While some metals (e.g., calcium, magnesium, sodium, potassium, iron, etc.) are essential to biological functions, including cellular functioning, certain metals have no functional effects in the body and are harmful to it. The metals of particular concern in relation to harmful effects on health are mercury (Hg), lead (Pb), cadmium (Cd), chromium (Cr), tin (Sn), and arsenic (Ar). The toxicity of these metals is in part due to the fact that they accumulate in biological tissues much faster than they are excreted, a process known as bioaccumulation. Bioaccumulation occurs in all living organisms as a result of exposure to metals in food and the environment, including in food animals such as fish and cattle as well as humans. Moreover, these metals can become more concentrated in food stuffs as macronutrient products are isolated from the bulk materials from which they are derived (e.g., carbohydrates, proteins, and/or fats).

As noted above, the concern in relation to the toxicity of certain metals vary depending on the metal. Some metals produce potential effects on the brain and intellectual development of young children (e.g., mercury, lead, etc.). Long-term exposure to certain metals (e.g., lead) can cause damage to the kidneys, reproductive and immune systems in addition to effects on the nervous system. Some metals (e.g., cadmium) are toxic to the kidney, and others (e.g., tin) can cause gastrointestinal irritation and upset. Some metals (e.g., arsenic) are of concern because of they cause cancer. Given the wide spectrum of effects on health and the fact that these toxic metals accumulate in the body, it is important to control levels in foodstuffs in order to protect human health.

Some embodiments disclosed herein pertain to chelators (e.g., chelants) that reduce and/or remove metals from food products. In some embodiments, one or more chelators are added to a solution or mixture of food product. In some embodiments, the chelators bind to one or more metal ions (forming a complex) in the solution or mixture. In some embodiments, the complexes that are to be removed from the food product are then rinsed from the food product (e.g., where the complexes are soluble, substantially soluble, or have greater solubility than the food product). In some embodiments, the food product is rinsed from the metal complexes (e.g., where the food product is soluble, substantially soluble, or has greater solubility than the metal complexes). In some embodiments, the complex comprises a flocculent or a floating mass that can be skimmed or decanted from a soluble or insoluble solution or mixture of liquid and food product.

In some embodiments, the metal complexes can be separated from the food product by filtration, decanting, and/or centrifugation. For example, in some embodiments, where the complexes are substantially or completely soluble and the food product is substantially insoluble or less soluble than the complex (e.g., a solid suspended solution as a mixture), the mixture is decanted and the supernatant contains the metal complex while the solid contains a food product with a reduced metal content. In some embodiments, prior to decanting, the mixture is centrifuged to separate the solid and liquid phases. In some embodiments, decanting is performed by pouring, sucking (e.g., by vacuum), or otherwise removing the supernatant from the solid. In some embodiments, the mixture is filtered and the filtrate containing the metal complex is removed from the filter cake, which contains the purified food product. In some embodiments, ultrafiltration, dialysis, or microfiltration methods can be used to remove the filtrate from solids.

Without being restricted to a particular theory, it is believed that the chelators capture and bind the heavy and other metals and carry the metals from, for example, a grain and/or vegetable protein matrix through a filtration device which retains the protein matrix. The filtration device allows the complex to leave the food product suspension, which can then be isolated. The chelator solubilizes metals and can be flushed out of the matrix using water. In some embodiments, the use of peptides allows heavy metal remediation after a food product is already prepared and/or in process metal removal during the preparation of an initial processed organic food product.

In some embodiments, the chelators disclosed herein are organic, organic certified and/or organic certifiable. In some embodiments, the organic, organic certified and/or organic certifiable chelator is a metal chelating agent that is naturally occurring or that is produced using organic certified techniques. In some embodiments, by using an organic chelator, an organic food product can isolated from the bulk organic food source. In some embodiments, the organic, organic certified or organic certifiable chelator is a metal chelating agent that can be isolated from natural sources or that is produced using organic certified techniques. In some embodiments, the chelator is used to prepare a food product that is organic and/or organic certifiable and that has reduced heavy metal content. In some embodiments, the chelator is used to prepare an organic protein isolate, starch isolate, or fat isolate. In some embodiments, the organic chelator is used to prepare an organic protein isolate or other food product that is organic certifiable with reduced metals.

In some embodiments, the process can be done using any of the following chelators, other chelators that accomplish the goal of organic certifiable heavy metal removal, and combinations thereof. In some embodiments, any one of the steps or parameters disclosed below can be combined. In some embodiments, steps can be omitted or combined in any way to achieve chelation of metals in food products to reduce the metal content of those foods.

In some embodiments, the chelator comprises citric acid or a salt thereof. In some embodiments, the chelator comprises an hydrolytically prepared peptide or oligopeptide (a “peptide chelator”), a mixture thereof, and/or salts thereof. In some embodiments, the chelator can be ethylenediaminetetraacetic acid (EDTA) or salts thereof. In some embodiments, one or more of citric acid, the peptide chelator, and/or the EDTA are used in combination.

In some embodiments, the peptide chelator is derived from plant (e.g., grain, vegetable, etc.) peptides produced by enzymatic and/or chemical hydrolysis of the proteins. In some embodiments, the enzyme and chemical hydrolysis process allows the production of an organic chelating agent for the reduction of heavy metals in grain and vegetable proteins. In some embodiments, one or more enzymes are used to prepare the peptide chelator. In some embodiments, the enzyme is an endopeptidase. In some embodiments, these enzymes cleave the proteins into peptide fragments selectively between specific amino acid sequences. In some embodiments, one or more acid endopeptidases and/or alkaline endopeptidases are used. In some embodiments, the acid endopeptidase enzymes are used in acidic environments. In some embodiments, the acid endopeptidase enzymes are used in a solution with a pH equal to or less than about: 2, 6.5, or ranges including and/or spanning the aforementioned values. In some embodiments, the acid protease enzymes are selected from one or more of pepsin, papain, carboxypeptidase and the like. In some embodiments, the alkaline endopeptidase enzymes are used in a basic pH solution. In some embodiments, the alkaline endopeptidase enzymes are used in a pH less than or equal to about: 7.0, 12, or ranges including and/or spanning the aforementioned values. In some embodiments, the alkaline endopeptidase enzymes include one or more of trypsin, chymotrypsin, thermolysin, and the like. In some embodiments, the pH of the solution used to prepare the peptide chelator is less than or equal to about: 2, 3, 4, 5, 6, 7, 8, 9, 10, 11, or ranges including and/or spanning the aforementioned values. In some embodiments, the enzyme includes one or more of Alcalase®, or DSM Maxipro BAP™. In some embodiments, these endopeptidase enzyme hydrolysis reactions are performed at temperatures equal to or below about: 4° C. and 80° C., or ranges including and/or spanning the aforementioned values. In some embodiments, the endopeptidase enzyme hydrolysis reaction is performed at a temperature greater than or equal to about 50° C. In some embodiments, the enzymatic hydrolysis reactions are performed at temperatures less than or equal to about: 4° C., 10° C., 20° C., 40° C., 50° C., 60° C., 80° C., 99° C., or ranges including and/or spanning the aforementioned values. In some embodiments, the enzymatic hydrolysis is performed for a period of time is less than or equal to about: 1 hour, about 2 hours, about 4 hours, about 6 hours, about 10 hours, or ranges including and/or spanning the aforementioned values. In some embodiments, the process is then quenched by deactivating the enzyme, for example, by heating the mixture to above about: 60° C., 80° C. 85° C., 90° C., 99° C., or ranges including and/or spanning the aforementioned values.

In some embodiments, one or more of the endopeptidase enzyme(s) is added to a grain protein solution. In some embodiments, the pH is adjusted with an alkali such as sodium or potassium hydroxide, or trisodium phosphate. In some embodiments, the pH is adjusted with an acid such as hydrochloric, citric, or phosphoric acid. In some embodiments, the pH is adjusted depending on the type or specific enzyme(s) used. In some embodiments, the solution of protein and enzyme (and/or another hydrolytic reagent) is agitated a period of time to cleave the peptides from the main grain protein chains. In some embodiments, where an enzyme is used, once a desired peptide chelator profile is achieved, the enzyme is denatured or otherwise deactivated. In some embodiments, for instance, the enzyme milieu is heated to above 85° C. for a period of time to deactivate the enzyme(s).

In some embodiments, peptide chelator is produced from the same food source (e.g., the same type of animal, grain, and/or vegetable source) as the food product being treated. In some embodiments, peptide chelator is produced from a different food source than the food product being treated.

In some embodiments, the peptide chelator comprises a crude protein hydrolysate, containing e.g, a mixture of peptides, oligopeptides, and/or amino acids. In some embodiments, certain fractions of the crude protein hydrolysate are fractionated and/or separated and/or concentrated prior to use as a peptide chelator, via well-known separation techniques such as those based on molecular weight, charge and/or binding affinity. In some embodiments, metal-binding peptide components of the hydrolysate are enriched by affinity separation techniques (batch-wise or chromatography), in which metals are immobilized on beads or separation media and crude hydrolysate is exposed to the affinity media. Non-binding fractions can be washed out and then the metal-bound fraction can be displaced from the metal by higher affinity binders (counter ions, etc.), collected and/or concentrated prior to use as peptide chelators. In some embodiments, certain fractions of the crude protein hydrolysate are fractionated and/or separated and/or concentrated using one or more of filtration, density centrifugation, etc. In some embodiments, the peptide chelator comprises mixture of peptides, oligopeptides, and/or amino acids used as isolated after a hydrolysis of a protein from a plant source. In some embodiments, the peptide chelator comprises one or more multifunctional acid peptides (e.g., di-carboxylic acids, tri-carboxylic acids, tetra-carboxylic acids, or more) with or without amino acid spacers, or other spacers between the acids. In some embodiments, these multifunctional acids bind metals to form metal complexes. In some embodiments, the peptide chelator comprises one or more multifunctional amine-peptides (e.g., di-carboxylic acids, tri-carboxylic acids, tetra-carboxylic acids, or more) with or without amino acid spacers between the amines. In some embodiments, these multifunctional amines bind metals to form metal complexes. Acid and amine functional groups can come from any amino acid of the natural amino acids which comprise both an acid and an amine terminal end (e.g., alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and/or valine). The binding acid or amine can also result from the side chains of the amino acids, for example: glutamic acid and/or aspartic acid (acids); tryptophan, glutamine, lysine, histidine, asparagine, glutamine, and/or arginine (amines and/or guanidinium). In some embodiments, the peptide chelator comprises one or more thio or hydroxyl substituents that bind to the metal (e.g., serine, threonine, cysteine, methionine, tyrosine).

In some embodiments, the peptide chelators are isolated based on a molecular weight fraction of the hydrolytically treated protein. In some embodiments, the peptide chelators comprise a protein hydrolysate having one or more peptides of different molecular weight. In some embodiments, the protein hydrolysate is a plant protein hydrolysate generated by enzymatic digestion of a plant protein source. In some embodiments, the protein hydrolysate has one or more peptides that range in molecular weight from about 500 kD to about 25,000 kD. In some embodiments, one of more of the peptides is further purified (e.g., by size exclusion and/or ion exchange chromatography) and used as the peptide chelators. In some embodiments, the number average molecular weight (g/mol) and/or weight average molecular weight (g/mol) of the peptide chelator is equal to or less than about 500, 1000, 2000, 5000, 10,000, 15,000, 20,000, 25,000 or ranges including and/or spanning the aforementioned values. In some embodiments, the molecular weight (g/mol) of the peptide chelator is equal to or less than about 500, 1000, 2000, 5000, 10,000, 15,000, 20,000, 25,000 or ranges including and/or spanning the aforementioned values.

In some embodiments, mixtures of these amino acids with their varying functional groups bind to metals to form complexes. In some embodiments, amino acid configurations that result in 5-membered rings or 6-membered rings can provide more favorable binding orientations (e.g., between the thiol, amine, and metal in, for example, serine), but are not required. Such configurations include those including GHK complexes (e.g., binding of a metal by the glycine amine and amide and the imidazole of the histidine). Single amino acids and amino acid chains (e.g., 2, 3, 4, 5, 6, or more in length) can be used as chelating agents.

In some embodiments, other chelating materials can be used in addition to or instead of those described above. In some embodiments, the chelating agents are derived from plant materials, for example, algae, tea saponin, humic acid, potato peels, sawdust, black gram husk, eggshell, coffee husks, sugar beet pectin gels, citrus peels, papaya wood, maize leaf, leaf powder, lalang, leaf powder, rubber leaf powder, peanut hull pellets, sago waste, saltbush leaves, tree fern, neem bark, grape stalk, rice husks, spent grain (e.g., from brewery), sugarcane bagasselfly ash, wheat bran, comcobs, weeds (Imperata cylindrical leaf powder), fruit/vegetable wastes, cassava waste, plant fibres, tree barks, Azolla, alfalfa biomass, cottonseed hulls, soybean hulls, pea hulls. Douglas fir bark, walnut shell, Turkish coffee, nut shell, lignin, sphagnum moss peat, bamboo pulp, orange peel (white inner skin), orange peel (outer skin), senna leaves, and combinations thereof.

In some embodiments, the metals removed include metals having an atomic weight that is greater than or equal to about: 63.5, 100, 200.6, or ranges including and/or spanning the aforementioned values. In some embodiments, the metals removed and/or reduced include one or more of arsenic, zinc, copper, nickel, mercury, cadmium, lead, selenium, and chromium. In some embodiments, the chelating agents bind to, remove, and/or reduce metals having a specific gravity of greater than about: 3.0, 5.0, 10.0, or ranges including and/or spanning the aforementioned values.

In some embodiments, the amount of chelator used to treat the food product is based on a dry measurement. For instance, in some embodiments, a 2% dry weight measure of chelator to food product indicates 2 grams of chelator for every 98 grams of food product (2 g chelator/100 g total dry weight). In some embodiments, the dry weight measure of chelator used to treat the food product is less than or equal to about: 0.5%, 1%, 2%, 5%, 10%, or ranges including and/or spanning the aforementioned values.

In some embodiments, the amount of chelator (or combination of chelators) used to treat the food product is based on a weight percent measure. For instance, in some embodiments, the treated formula comprises a food product (e.g., a mixture and/or suspension of plant matter, such as, protein, protein isolate, carbohydrate, etc.) in a liquid (e.g., water). In some embodiments, a 2 wt % measure of chelator to formula indicates 2 grams of chelator (e.g., a solute) for every 100 grams of formula (e.g., the food product, chelator, and liquid solvent). In some embodiments, the wt % chelator(s) used to treat the formula is less than or equal to about: 0.0125, 0.25%, 1%, 2%, 5%, 7.5%, 10%, or ranges including and/or spanning the aforementioned values. In some embodiments, the weight percent of dry food product matter in the formula is equal to or greater than about: 10%, 20%, 30%, 40%, 60%, 80%, 90%, 99%, or ranges including and/or spanning the aforementioned values.

In some embodiments, a chelator is not used and, instead, a liquid without or substantially without an added chelator is used instead to remove metal from the food product. For example, in some embodiments, one or more combinations of liquids such as water, ethanol, etc. are used to remove the metal.

In some embodiments, metal removal and/or reduction can be performed at different pH values. In some embodiments, varying the pH of the solution in which the chelation and/or filtration takes place increases the solubility of, for example, the metal complex (where present) or metal allowing it to be removed from, for instance, a suspended food product (e.g., where the metal complex is soluble and the food product is not). In other embodiments, for example, where the complex (where present) or metal is more insoluble than the food product, the food product's solubility can be increased by varying the pH of the solution which it is in. In some embodiments, the pH of the solution used to perform the complexation and metal reduction is less than or equal to about 2, 3, 4, 5, 6, 7, 8, 9, 10, 11, or ranges including and/or spanning the aforementioned values.

In some embodiments, metal removal and/or reduction can be performed using methods at different solution temperatures. In some embodiments, varying the temperature of the solution in which the chelation (where performed), metal dissolution, and or filtration takes place increases the solubility of, for example, the metal complex (where present) or metal allowing it to be removed from, for instance, a suspended food product (e.g., where the metal complex is soluble and the food product is not). In other embodiments, for example, where the complex (where present) or metal is more insoluble than the food product, the food product's solubility can be increased by varying the temperature. In some embodiments, the temperature of the solution used to perform the complexation and/or metal reduction is less than or at equal to about 4° C., 10° C., 20° C., 40° C., 60° C., 80° C., 99° C., or ranges including and/or spanning the aforementioned values.

In some embodiments, microfiltration, ultrafiltration, and/or nanofiltration membrane technologies are used to retain the target food product (e.g., grain and/or vegetable protein) while allowing chelating agent(s) and/or other impurities to pass the membranes resulting in reduction of heavy metals the food product. In some embodiments, the filtration is performed with a microfiltration membrane having a molecular weight cutoff (in Daltons) of equal to or less than about: 10,000, 100,000, 200,000, 500,000, 1,000,000, or ranges including and/or spanning the aforementioned values. In some embodiments, the filtration is performed with a microfiltration membrane having a pore size equal to or less than 0.1μ, 0.5μ, 0.8μ, 1.0μ, 1.2μ, 1.4μ, 2.0μ, or ranges including/or spanning the aforementioned values. In some embodiments, a microfiltration membrane with a molecular weight cutoff of about 100,000 Daltons to 4 microns is used. In some embodiments, the filtration is performed with an ultrafiltration membrane having a molecular weight cutoff (in Daltons) of equal to or less than about: 700, 10,000, 50,000, 100,000, 500,000, 800,000, or ranges including and/or spanning the aforementioned values. In some embodiments, the filtration is performed with a nanofiltration membrane having a molecular weight cutoff (in Daltons) of equal to or less than about: 100, 300, 500, 1,000, or ranges including and/or spanning the aforementioned values. In some embodiments, the microfiltration, ultrafiltration, and/or nanofiltration membranes are composed of inorganic and/or organic substrates. In some embodiments, the microfiltration, ultrafiltration, and nanofiltration membrane modules can be composed of spiral, hollow fiber, plate and frame, tubular, and/or extruded membrane configurations.

Some embodiments involve the use of fabric and/or screen filter technologies to retain the target grain and/or vegetable products (e.g., proteins) while allowing chelating agent(s) and/or other impurities to pass the membranes resulting in reduction of heavy metals. In some embodiments, the fabric can be of any natural or manmade woven or extruded material. In some embodiments, the screen can be of any metallic or plastic material. In some embodiments, the screen can have a mesh opening equal to or less than about: 10 mesh, 100 mesh, 400 mesh, or ranges including and/or spanning the aforementioned values. In some embodiments, the filter system uses a fabric and/or screen mesh, and/or sintered stainless steel or glass filter.

In some embodiments, the filtration system is in a configuration of a cartridge filter, plate and frame filter dual continuous belt filter, vacuum drum filter, flat plane filter, inclined filter, or incrementing belt filter.

In some embodiments, the filtration process is performed using a solution at a temperature less than or equal to about 4° C., 10° C., 20° C., 40° C., 60° C., 80° C., 99° C., or ranges including and/or spanning the aforementioned values. In some embodiments, the membrane system operating pressure is performed at a pressure of equal to or at least about: 1 bar, 10 bars, 20 bars, 40 bars, or ranges including and/or spanning the aforementioned values. In some embodiments, the membrane system operating pressure is as required by the system and the membrane type and composition. In some embodiments, the fabric and/or screen filter system operating pressure can be operated at a vacuum (e.g., on the filtrate side of the filter).

In some embodiments, the filtration step and membrane system uses water devoid of or substantially devoid of heavy metals.

In some embodiments, this diafiltration process can rinse a variable volume of water through the membrane removing the heavy metal chelating complex until the desired level of heavy metal remains in the protein matrix. In some embodiments, the diafiltration water can be employed at any pH desirable in the range stated above and can also be varied from the beginning of diafiltration until diafiltration is complete. In some embodiments, the diafiltration water can be employed at any temperature desirable in the range stated above and can also be varied from the beginning of diafiltration until diafiltration is complete. In some embodiments, the operating pressure can be varied as desired at any time during the diafiltration process in the range stated above.

In some embodiments, rinses having a pH different than the initial chelating solution can be used to rinse metal complexes from grain and vegetable proteins (e.g., using microfiltration, ultrafiltration, nanofiltration membrane technologies, or fabrics) to allow retention of same grain or vegetable proteins while allowing the altered pH water to pass carrying with it heavy metals removed from said proteins. In some embodiments, liquid rinses at various pH levels can be mixed or matched to remove various metals (or complexes) that may have solubilities that vary with pH.

In some embodiments, filtration is not used and the soluble fraction of a mixture is removed by decanting (e.g., using a centrifugal decanter). In some embodiments, a centrifuge can be used to separate the insoluble fraction from the solution. In some embodiments, a stacked disc centrifuge and/or a centrifugal basket centrifuge can be used to separate the insoluble fraction from the solution (supernatant). In some embodiments, the supernatant is poured, pumped, or sucked away with a vacuum from the solid fraction.

In some embodiments, the chelators (or methods) disclosed herein allow a reduction in the amount (e.g., the weight or molar content) of one or more of metals (e.g., Hg, Pb, Cd, Cr, Sn, Ar) by at least about: 50%, 75%, 90%, 99%, 99.9%, or ranges including and/or spanning the aforementioned values. In some embodiments, the chelators (or methods) disclosed herein reduce the amount of one or more of the metals in the food product to equal to or less than about: 10 ppm, 1 ppm, 100 ppb, 1 ppb, or ranges including and/or spanning the aforementioned values. In some embodiments, the metals are reduced to levels found acceptable for consumption by the FDA and/or the European Food Safety Authority. In some embodiments, for example, Ar is reduced to equal or less than about 125 ppb, Cd is reduced to equal or less than 250 ppb, Pb is reduced to equal or less than about 125 ppb, Hg is reduced to equal or less than about 29 ppb.

The methods disclosed herein can be used for preparing maltodextrin and rice protein from rice (e.g., white rice, brown rice, etc.) and rice brokens (e.g., rice grain that is broken and not whole and which is usually damaged during the bran removal step which is a mechanical abrasion of the rice grain) that has reduced heavy metal content or where heavy metals have been substantially completely removed. In some embodiments, metal chelators can be introduced during the production of a plant-derived food products to remove metals. In some embodiments, methods for removing metals by using washes at particular stages during the rice product preparation are used. In some embodiments, based on the techniques used to remove these metals, the products disclosed herein are hypoallergenic and can retain their “organic food” status.

### EXAMPLES

### Example 1

### Rice Testing

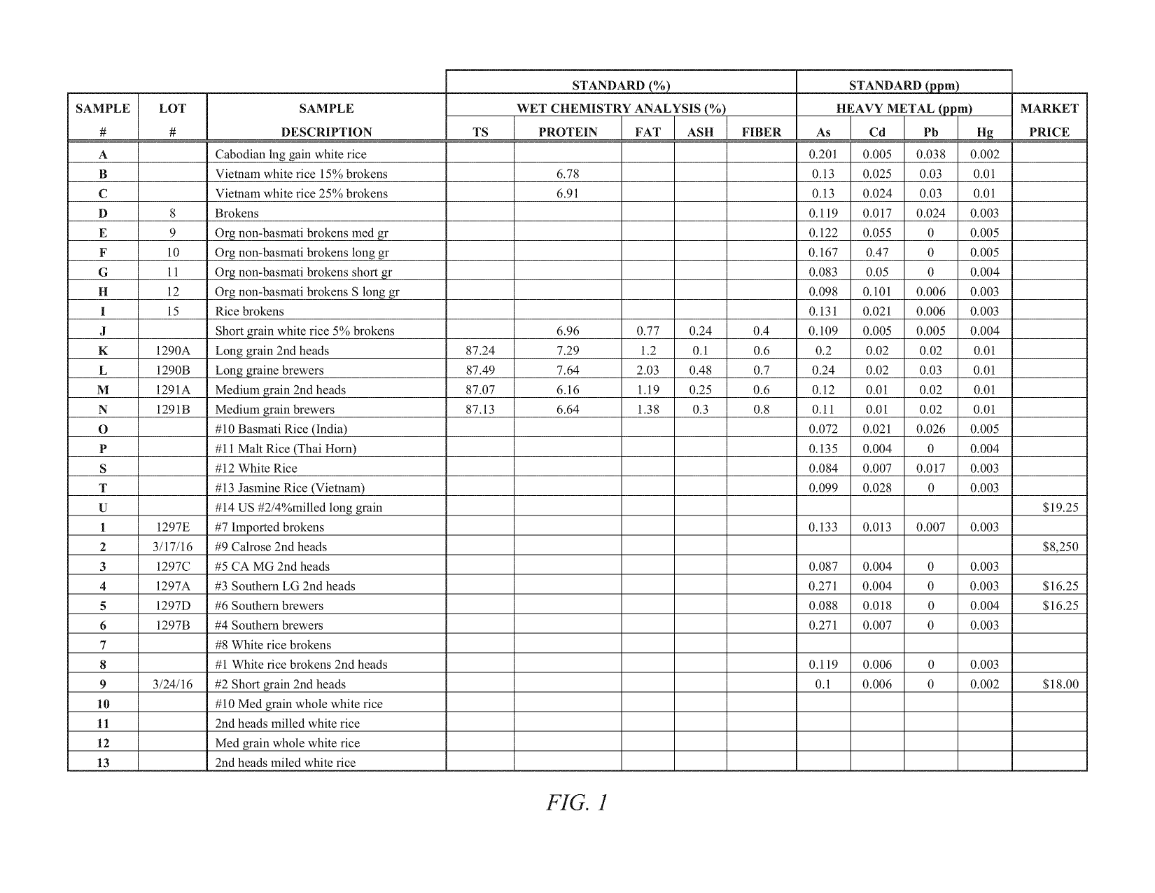

To determine the amount of As, Cd, Pb, and Hg in a variety of rice sources, testing was performed. The testing results are shown in FIG. 1. Briefly, the amount of the heavy metals in several rice sources (e.g., from different countries, species of rice, suppliers, etc.) was measured by atomic absorption spectroscopy (ICP-MS) (method reference number AOAC: 993.14). Additionally, as shown in FIG. 1, other components characterized in the test samples were moisture and total solids (see, e.g., Samples B, C, and K-N) (forced air oven 130° C.) (by reference method AOAC: 926.07, 925.10, 934.06, 969.38, 977.21, AACC: 44.15 44.3), as well as the total protein (Dumas) (by reference method AOAC: 992.15, AACC: 46-30), fat (gravimetric) (by reference method AOAC: 948.15, 922.06, 925.32, 950.54, 922.09), ash (overnight) (by reference method AOAC: 923.03), and fiber content of certain rice samples (e.g., Samples B, C, and K-N). All of these measurements were performed by an independent analytical laboratory using the noted referenced methods.

For the metal reduction trials performed, a sample of rice protein isolate with elevated heavy metals was used to obtain data and validate the ability of these techniques to reduce the heavy metal content in the final treated and dried protein powder. All samples were corrected to the same total solids content. Because the heavy metal content is measured as parts per billion (ppb) of the total weight of the sample and because the dried samples can contain varying amounts of moisture, to make sure all values are comparable the samples were corrected to bone dry basis. An example of how this is done is explained below in the next paragraph.

Assume powder or rice sample #1 contains 10% moisture (90% powder) and measures 1000 ppb of heavy metal M⁺⁺. Assume powder or rice sample #2 contains 13% moisture (87% powder) and measures also 1000 ppb of heavy metal M⁺⁺. If sample #1 is corrected to a bone dry basis the heavy metal content will be corrected by multiplying the 1000 ppb by 100%/90%=1.111 and the corrected heavy metal content will be 1000 ppb×1.111=1111 ppb. If sample #2 is corrected to a bone dry basis the heavy metal content will be corrected by multiplying the 1000 ppb by 100%/87%=1.149 and the corrected heavy metal content will be 1000 ppb×1.149=1149 ppb. It can be seen that before correction the conclusion would be that both samples contain the same amount of heavy metal when in actuality there is a 38 ppb difference.

This information was used to measure the amount of heavy metals in the target rice protein isolate as the basis for the removal protocol then measure and compare the effects of each chelation and wash protocol on the reduction of the heavy metal measured in the treatment of the starting rice protein isolate with the different chelation and wash protocol.

The following table shows the average amount of each As, Cd, Pb, and Hg present (in ppm) in the random rice samples separated by the country/region of origin.

TABLE 1

| AVERAGE HEAVY METAL RESULTS | | | | |
|---|---|---|---|---|
| (ppm) | | | | |
| As | Cd | Pb | Hg | |
| 0.13676 | 0.03804 | 0.01116 | 0.005 | average all |
| 0.1285 | 0.008357 | 0.008 | 0.004643 | average American |
| 0.115714 | 0.059571 | 0.011929 | 0.004286 | average Asian |

As shown, of the rice samples tested, on average the American sources appeared to have higher levels of As and Hg, while the Asian sources appeared to have higher levels of Cd and Pb. Based on the techniques developed for reducing metals described herein, subjecting particular rice sources to tailored chelating techniques for particular metals and/or combinations of chelation techniques could remove and/or reduce metal levels to suitable levels while producing a food that retains an “organic food” designation.

### Example 2

Comparison of Various Chelating Agents and/or Methods for Removing Metals

The experiments disclosed herein were performed using chelating compounds (including rice-based peptide chelators, citric acid, EDTA, etc.). The heavy metal content in rice and rice extract products (e.g., protein) was tested. It was determined that heavy metals found naturally in rice can be bound by organometallic coordination to chelators (e.g., rice protein peptides) to remove and/or reduce heavy metals from, for example, protein extract fractions of plant-derived food products. In some embodiments, washes (e.g., water washes) performed during the preparation of the rice product can be used to remove heavy metals from plant-derived food products. In some embodiments, the washes performed during the preparation can be performed at various pH levels to remove certain heavy metals from plant-derived food products. In some embodiments, the use of these chelators (and/or wash methods) can be performed in a GRAS (“generally recognized as safe”) and “organic” compliant way to reduce and/or substantially remove metals from a food product. In some embodiments, the chelators and wash methods disclosed herein can be used to prepare organic products. In some embodiments, water washes alone performed during the preparation of the product remove heavy metals.

### Testing Overview

The capacity for rice-based peptide chelators, citric acid, and EDTA to remove metals from rice products was measured as was the ability of rinse solutions during the preparation of protein products. The metal levels of the protein product prior to treatment and after exposure to the chelator (and or the wash solution) were measured. To test the ability of chelators (rice-based peptide chelators, citric acid, and EDTA) to remove heavy metals, a rice protein product with elevated levels of heavy metals and at various pH values was exposed to each chelator separately. The solution was then rinsed via centrifugation to remove the chelator and heavy metals. Where chelator-free washes were used, the pH was varied without the addition of a chelant.

### Experimental Procedures

The rice-based protein chelator (e.g., the peptide chelant) was prepared by hydrolyzing a Silk 80 AXIOM product. Axiom's Silk 80 product is a rice protein isolate produced from whole and/or broken white rice grains. Rice grain is normally about 7% protein and 89% starch and the Silk 80 product is protein that has been removed from the grain and purified to high levels of protein content. The protein isolate is generally 75% to 96% protein purity on a dry weight basis. It is manufactured by converting the starch portion via enzymatic action into lower molecular weight carbohydrate fractions and then removing the lower molecular weight carbohydrate fractions via filtration, decantation, or centrifugation to reduce the carbohydrate, ash, and fat content relative to the protein in the final isolate. Briefly, a rice-based peptide chelator was prepared by the following procedures. 100 g of Silk-80 (AXIOM protein product: Moisture: 2.7%; Protein 81%; Fat 1.2%; Ash <4.5%, Fiber: <10%, Carbohydrate <13.3%) was placed into agitator and agitated with 233 g of hot 50° C. RO/DI water producing 300 g of solution (˜30% total solids). To this solution was added 3.6 g (300 ppm) CaCl₂. To this solution was added 10% NaOH to bring pH to 8.5 (+/−0.1). To this mixture was added Alcalase® (an alkaline protease enzyme) at 2% by weight of the protein dry weight. The solution was agitated at 50° C. for 4 hours. After 4 hours, the mixture was heated to 80-85° C. and held for 10 minutes to deactivate the enzyme. After 10-minute hold time the mixture was cooled to 50° C., the mixture was then centrifuged causing the solids to separate via G-forces from the peptide solution. The supernatant containing the peptide chelators was decanted and the weight of total solids was measured. The supernatant was collected for use as a chelator. A dilute solution of peptides was obtained from this enzyme hydrolysis of rice protein. This product was filtered and stored for use during chelation experiments.

Food grade Citric acid chelant was used as purchased from Hawkins chemical supply company. Food grade EDTA chelant was used as purchased from Santa Cruze Biotechnology, Inc.

After the chelators were prepared and/or purchased, a rice protein isolate product with elevated levels of heavy metals was exposed to each chelator separately as a mixture and then the chelators were rinsed from the protein product via washing and recovery of the protein by application of a centrifuge.

For each of the tests below, a bulk solution of protein was prepared from a rice protein isolate powder (Moisture: 4%; Protein (purity); 80.7%; Fat: 3.4%; Ash: <4.5%; Fiber: <10%; Carbohydrates: <11.4%; Heavy Metals (analyzed in triplicate): Arsenic (range 88-114 ppb): 101 ppb used; Cadmium: (range 1199-1418 ppb): 1199 ppb used; Lead (range 240-310 ppb): 310 ppb used; Mercury (range 23.4-29.5 ppb) 29.5 ppb used).

In general for the test, a chelant (or no chelant) was added, the pH was adjusted, and the treated protein was agitated with the chelant solution and then isolated, and the content of heavy metals was tested. Briefly, for a particular chelant, a 480 g of deionized water was heated to 50-70° C. and agitated. To the water was added 120 mL of starting rice protein solution (a protein mixture having protein contaminated with higher than normal and various amounts of different heavy metals). From this 600 mL solution was taken three 200 g aliquots. The pH of the first solution was adjusted to pH of 3 using a solution of 10% by weight HCl (e.g., concentrated 38% HCl diluted to 10% by weight with water). The pH of the second solution was adjusted to pH 6 using a solution of 10% by weight HCl. The pH of the third solution was adjusted to pH 9 using a solution of 10% by weight of concentrated 50% NaOH. These procedures were performed for each chelant at three different pH values (e.g., pH 3.0, pH 6.0, and pH 9.0). The pH was measured with a temperature correcting pH meter. Each solution was agitated for 15 minutes at a temperature of 70° C.

To achieve the chelant heavy metal reduction, to the pH adjusted protein solutions described above was added enough chelant (peptide chelant, citric acid, EDTA) to afford a solution that is 2% weight of the chelant relative to the dry weight protein content (e.g., 2 g chelant relative to 100 g of dry plant protein). The mixtures were agitated for 15 minutes at a temperature of 70° C. at which time the solid fractions were separated by centrifugation. To achieve isolation of the solid protein fraction, samples were centrifuged at 9,000 RPM using a Perkin Elmer centrifuge. After 3 minutes of centrifuging, the supernatant was decanted off with a vacuum pipet. The rinse process was repeated 3 times (a 4× rinse by weight) by adding 120 mL of water at a temperature of 70° C., centrifuging, and decanting off the supernatant. The centrifugation and decanting steps can be repeated until the desired amount of rinsing is achieved. More or less centrifugation/rinse steps could be performed depending on the final amount of heavy metals desired in the final plant protein product. The final decanted protein solids were placed into a container, frozen, shipped overnight via carrier to a selected independent analytical laboratory, and analyzed for heavy metals and solids. The heavy metal content of the resultant protein solids fraction was then determined using atomic absorption spectroscopy. The supernatant solutions were also collected and frozen for analysis.

To test the ability of water at an elevated temperature (e.g., at a temperature of 70° C.) to remove heavy metals from plant protein, the rice protein product having elevated levels of heavy metals was prepared at pH values of 3, 6, and 9 as described above. The same procedures were performed as with the chelant except that no chelating agent was added to the protein fraction. The pH adjusted water and plant protein mixture was agitated and the resulting mixture was put through the identical centrifugation and washing cycles as was used as described above for the chelant containing mixtures. In some embodiments, the reduction of certain heavy metals from the food product can be achieved using water washes with water at a temperature of at least about: 5° C., 10° C. 30° C., 50° C., 70° C., 90° C., 95° C., or ranges including and/or spanning the aforementioned values. In some embodiments, the reduction of certain heavy metals from the food product can be achieved using water washes with water that has been pH adjusted to 2.0, 3.0, 4.0, 5.0, 6.0, 7.0, 8.0, 9.0, 10.0, 11.0, 12.0, or ranges including and/or spanning the aforementioned values.

### Results

All total solids were normalized with the respective HM data to ensure accurate analysis and conclusions from the test work as the dry solids have relatively no water to dilute the heavy metal content whereas when the protein is placed in a water mixture the heavy metals are diluted by the water and are measured on a total mass basis which includes the water. This will give a much lower level of heavy metals than exists on a dry weight basis so the results are corrected to a common solids concentration where the process was started and the amounts of heavy metals compared to the concentrations measured in the original starting solution solids concentration. This provides a more accurate comparison of the pre and post treatment heavy metal content of the protein mixture. Not all samples were exactly the same solids concentrations. For that reason, because a target initial solution of 30% total solids was desired, all values were corrected to the 30% solids value making the measured heavy metal results directly comparable to each other. The following paragraph provides a demonstrative theoretical calculation.

Starting heavy metal powder on a bone dry basis has 1000 ppb of a heavy metal M⁺⁺. To make an arbitrary 100 g starting solution of 30% total solids 30 grams of bone dry powder will be mixed with 70 g of water. When analyzed this sample will now have a content of 300 ppb of heavy metal M⁺⁺. Even though nothing has been done to the sample except dilute it to a 30% solution with water the heavy metal content of this liquid sample will not test out at 1000 ppm anymore. After processing, getting the filtration system to provide a final liquid protein sample at 30% is very difficult and drying the sample before analysis is not feasible. The resulting final liquid sample solids will need to be adjusted to the original target 30% to get a proper comparison to the starting material. To accomplish this correction let us say that the liquid sample coming from the separation system is 28% and at 28% the heavy metal concentration is measured at 150 ppb. This 150 ppb measurement is lower than the actual separation provided because of the slight dilution at 28%. So this liquid sample result of 150 ppb is corrected to 30% by multiplying the analytical result by 30%/28%=1.0714. The modified result is now 160.7 ppb which is ˜7% higher than the liquid analytical results showed. If the 150 ppm result was used it would show that the process was 7% more efficient at removing the heavy metals than was the actual case. This corrected value is more accurate hence the reason for performing the correction. The opposite is true in the event the liquid total solids from the separation process were higher than 30%. The correction of that value will be also needed to keep the results from understating the success of the process for removing the heavy metals if it was not corrected by using the same correction method. This same technique was used throughout all of the testing to ensure the heavy metals reported for all samples were comparable.

Target levels of heavy metals were equal to or below 125 ppb Ar, 250 ppb CD, 125 ppb Pb, and 29 ppb Hg. The data collected from each experiment described above is shown in Table 2.

TABLE 2

| | | TOTAL | HEAVY METAL CONC (ppb) | | | | TOTAL |
|---|---|---|---|---|---|---|---|
| pH | CHELANT | SOLIDS | As | Cd | Pb | Hg | HM CONC |
| FEED STOCK | | 22.6 | 101 | 1199 | 310 | 29.5 | |
| FEED STOCK (adj) | | 30 | 134 | 1592 | 412 | 39.2 | 2177 |
| 3.0 | WATER | 29.3 | 10 | 10 | 83 | 7.5 | |
| 3.0 adj | WATER | 30 | 10 | 10 | 85 | 7.7 | 113 |
| % REDUCTION | | | 92.4% | 99.4% | 79.3% | 80.4% | 94.8% |
| 3.0 | CITRIC | 32.8 | 12 | 12 | 80 | 9.2 | |
| 3.0 adj | CITRIC | 30 | 11 | 11 | 73 | 8.4 | 104 |
| % REDUCTION | | | 91.8% | 99.3% | 82.2% | 78.5% | 95.2% |
| 3.0 | EDTA | 29.9 | 12 | 232 | 63 | 8.4 | |
| 3.0 adj | EDTA | 30 | 16 | 232 | 66 | 8.2 | 322 |
| % REDUCTION | | | 91% | 85.4% | 84.6% | 78.5% | 85.2% |
| 3.0 | PEPTIDE | 31.2 | 15 | 20 | 79 | 8.7 | |
| 3.0 adj | PEPTIDE | 30 | 13 | 19 | 56 | 8.2 | 118 |
| % REDUCTION | | | 89.3% | 98.8% | 81.6% | 78.7% | 94.6% |
| 6.0 | WATER | 28.7 | 11 | 299 | 83 | 7.9 | |
| 6.0 adj | WATER | 30 | 12 | 313 | 87 | 8.3 | 419 |
| % REDUCTION | | | 91.4% | 80.4% | 78.9% | 78.9% | 80.7% |
| 6.0 | CITRIC | 34.1 | 18 | 194 | 75 | 9.3 | |
| 6.0 adj | CITRIC | 30 | 16 | 171 | 66 | 8.2 | 261 |
| % REDUCTION | | | 88.2% | 89.3% | 84% | 79.1% | 88% |
| 6.0 | EDTA | 32.6 | 18 | 57 | 31 | 9.2 | |
| 6.0 adj | EDTA | 30 | 17 | 53 | 27 | 8.5 | 106 |
| % REDUCTION | | | 87.6% | 96.7% | 93.1% | 78.4% | 95.1% |
| 6.0 | PEPTIDE | 33 | 23 | 216 | 78 | 8.9 | |
| 6.0 adj | PEPTIDE | 30 | 23 | 196 | 71 | 8.1 | 296 |
| % REDUCTION | | | 84.4% | 87.7% | 82.8% | 79.3% | 86.4% |
| 9.0 | WATER | 29.4 | 15 | 366 | 74 | 7.9 | |
| 9.0 adj | WATER | 30 | 15 | 374 | 76 | 8.1 | 472 |
| % REDUCTION | | | 88.6% | 76.8% | 81.7% | 79.4% | 78.3% |
| 9.0 | CITRIC | 32 | 14 | 269 | 60 | 8.7 | |
| 9.0 adj | CITRIC | 30 | 13 | 252 | 56 | 8.2 | 330 |
| % REDUCTION | | | 90.2% | 84.2% | 86.3% | 79.2% | 84.8% |
| 9.0 | EDTA | 30.2 | 20 | 76 | 40 | 8.9 | |
| 9.0 adj | EDTA | 30 | 20 | 76 | 40 | 8.8 | 144 |
| % REDUCTION | | | 85.2% | 95.3% | 90.3% | 77.4% | 93.4% |
| 9.0 | PEPTIDE | 32.5 | 23 | 379 | 87 | 9.11 | |
| 9.0 adj | PEPTIDE | 30 | 24 | 349 | 80 | 8.4 | 461 |

| | | | | | |
|---|---|---|---|---|---|
| % REDUCTION | 83.5% | 78% | 80.5% | 78.5% | 78.8% |

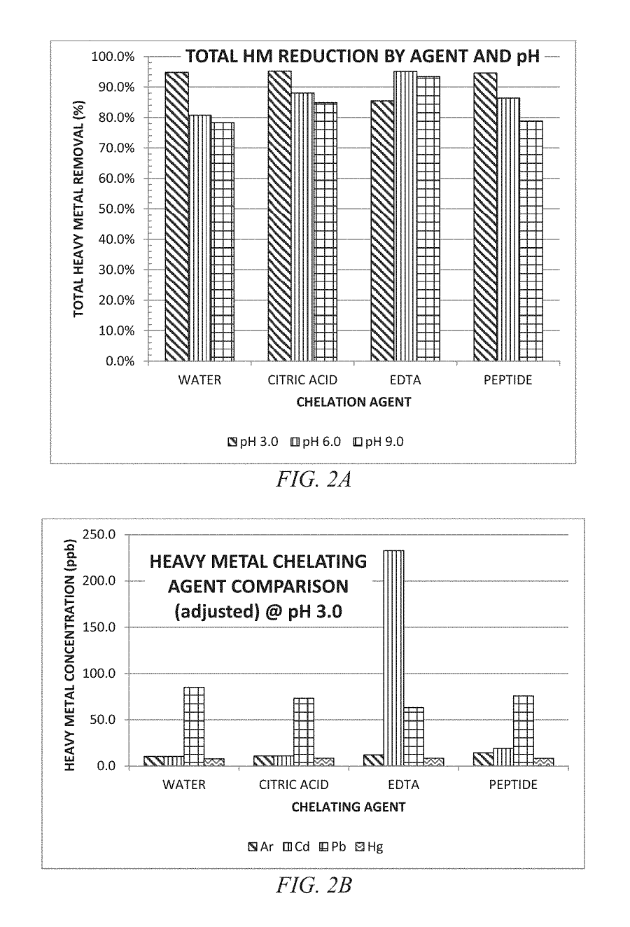

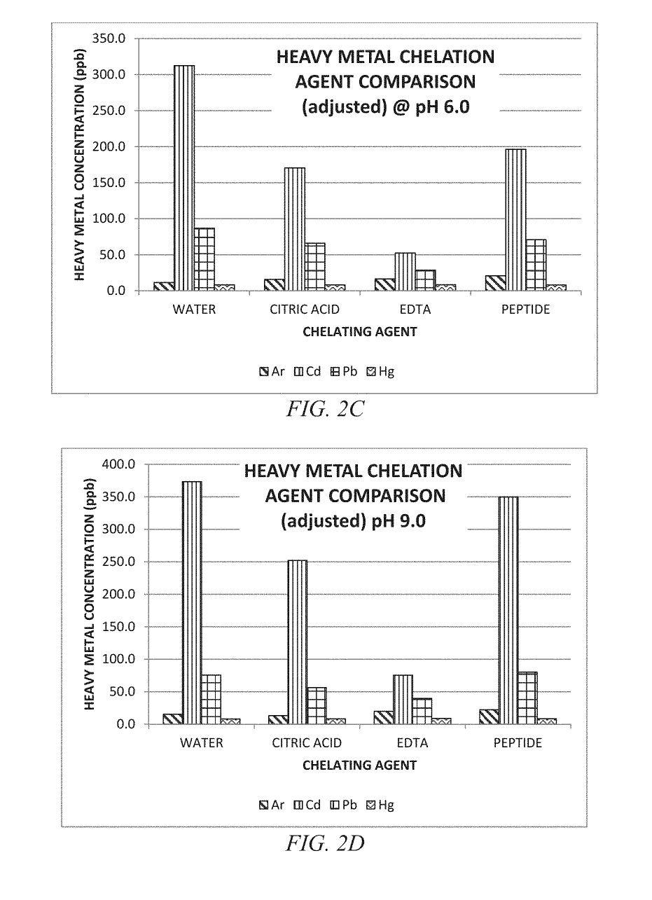

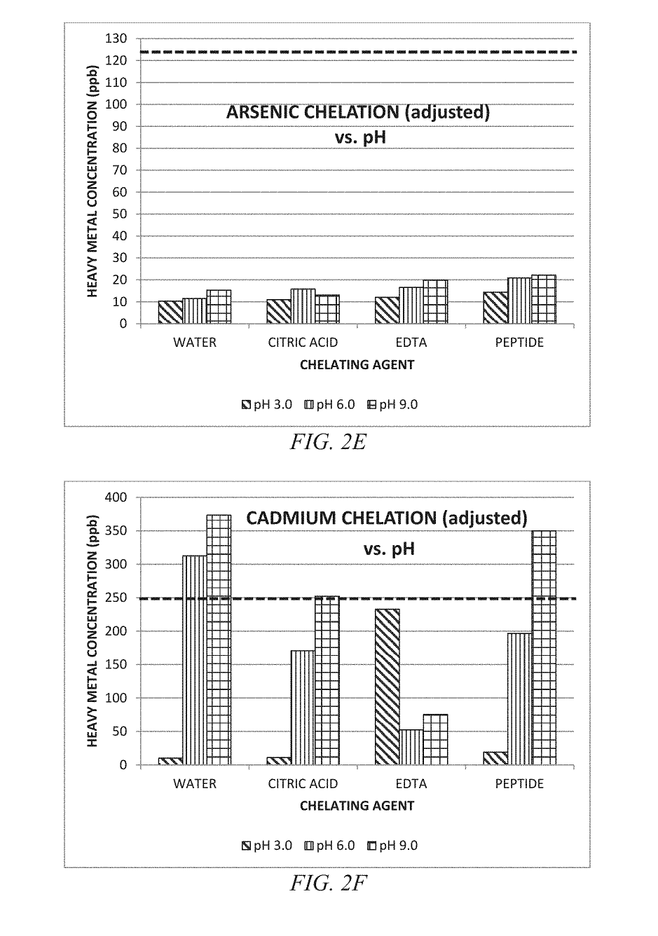

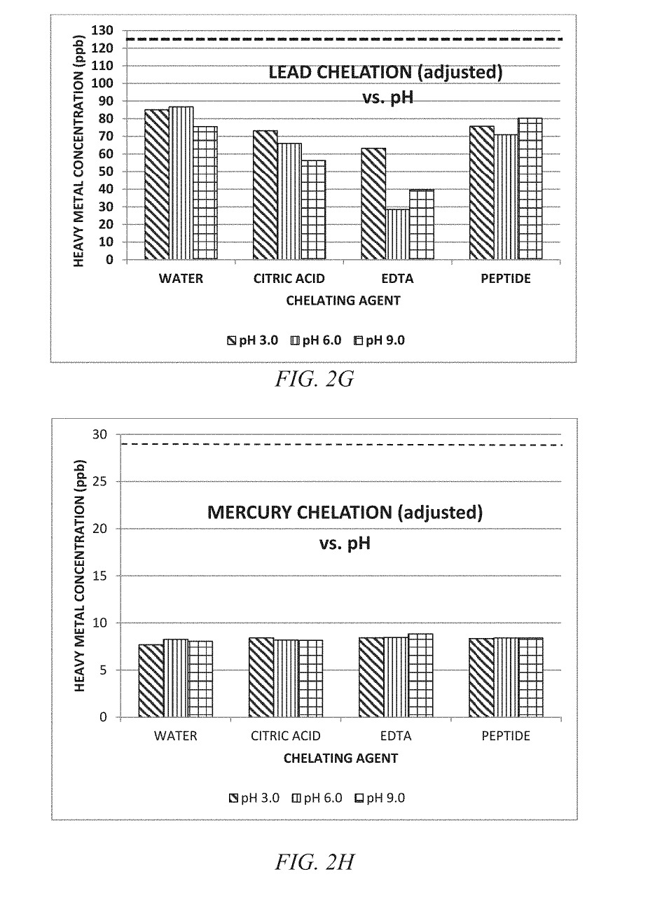

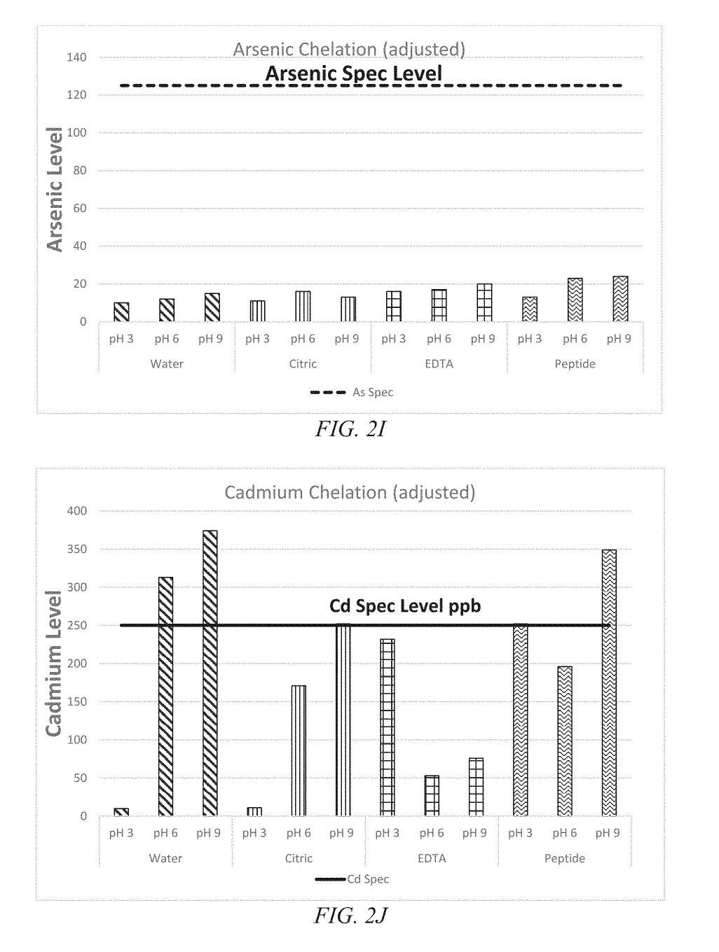

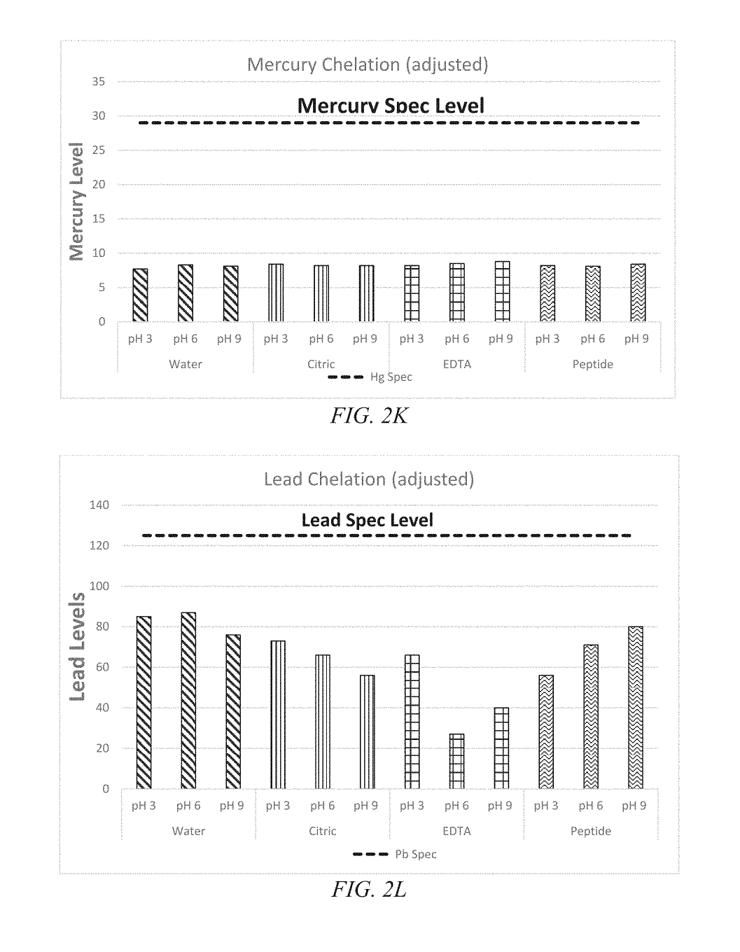

FIG. 2A provides an overview of the total % reduction of heavy metals using each chelator at each of three different pH values. As shown in FIG. 2A, all of the chelants tested reduced all the heavy metals tested by greater than 75%. As shown, some chelants reduced the levels by greater than or equal to 95% (e.g., citric acid at pH 3, EDTA at pH 6, and peptide at pH 3). Notably, the procedures for reducing heavy metal using hot water also reduced the heavy metal level by greater than or equal to 95%. Levels below the maximum allowable levels were achievable in all cases. Thus, organic protocols to remove the heavy metals were realized.

FIG. 2B shows the reduction of heavy metal at pH 3. As shown in FIG. 2B, in some embodiments, the peptide chelator can reduce the level of As from about 134 ppb to about 15 ppb at pH 3. In some embodiments, the peptide chelator can reduce the level of As from about 134 ppb to about 13 ppb at pH 3. In some embodiments, the peptide chelator can reduce the level of As by equal to or at least about 85% or about 95% at pH 3. In some embodiments, the peptide chelator can reduce the level of Cd from about 1199 ppb to about 20 ppb at pH 3. In some embodiments, the peptide chelator can reduce the level of Cd from about 1592 ppb to about 19 ppb at pH 3. In some embodiments, the peptide chelator can reduce the level of Cd by equal to or at least about 85% or about 99%. In some embodiments, the peptide chelator can reduce the level of Pb from about 310 ppb to about 79 ppb at pH 3. In some embodiments, the peptide chelator can reduce the level of Pb from about 412 ppb to about 56 ppb at pH 3. In some embodiments, the peptide chelator can reduce the level of Pb by equal to or at least about 75% or about 85% at pH 3. In some embodiments, the peptide chelator can reduce the level of Hg from about 29.5 ppb to about 8.7 ppb at pH 3. In some embodiments, the peptide chelator can reduce the level of Hg from about 39.2 ppb to about 8.2 ppb at pH 3. In some embodiments, the peptide chelator can reduce the level of Hg by equal to or at least about 70% or about 80% at pH 3.

As shown in FIG. 2B, in some embodiments, citric acid can reduce the level of As from about 101 ppb to about 12 ppb at pH 3. In some embodiments, citric acid can reduce the level of As from about 134 ppb to about 11 ppb at pH 3. In some embodiments, citric acid can reduce the level of As by equal to or at least about 85% or about 90% at pH 3. In some embodiments, citric acid can reduce the level of Cd from about 1199 ppb to about 12 ppb at pH 3. In some embodiments, citric acid can reduce the level of Cd from about 1592 ppb to about 11 ppb at pH 3. In some embodiments, citric acid can reduce the level of Cd by equal to or at least about 98% or about 99% at pH 3. In some embodiments, citric acid can reduce the level of Pb from about 310 ppb to about 80 ppb at pH 3. In some embodiments, citric acid can reduce the level of Pb from about 412 ppb to about 73 ppb at pH 3. In some embodiments, citric acid can reduce the level of Pb by equal to or at least about 75% or about 83% at pH 3. In some embodiments, citric acid can reduce the level of Hg from about 29.5 ppb to about 9.2 ppb at pH 3. In some embodiments, citric acid can reduce the level of Hg from about 39.2 ppb to about 8.4 ppb at pH 3. In some embodiments, citric acid can reduce the level of Hg by equal to or at least about 70% or about 80% at pH 3.

As shown in FIG. 2B, in some embodiments, EDTA can reduce the level of As from about 101 ppb to about 12 ppb at pH 3. In some embodiments, EDTA can reduce the level of As from about 134 ppb to about 16 ppb at pH 3. In some embodiments, EDTA can reduce the level of As by equal to or at least about 85% or about 90% at pH 3. In some embodiments, EDTA can reduce the level of Cd from about 1199 ppb to about 232 ppb at pH 3. In some embodiments, EDTA can reduce the level of Cd from about 1592 ppb to about 232 ppb at pH 3. In some embodiments, EDTA can reduce the level of Cd by equal to or at least about 80% or about 85% at pH 3. In some embodiments, EDTA can reduce the level of Pb from about 310 ppb to about 63 ppb at pH 3. In some embodiments, EDTA can reduce the level of Pb from about 412 ppb to about 66 ppb at pH 3. In some embodiments, EDTA can reduce the level of Pb by equal to or at least about 80% or about 85% at pH 3. In some embodiments, EDTA can reduce the level of Hg from about 29.5 ppb to about 8.4 ppb at pH 3. In some embodiments, EDTA can reduce the level of Hg from about 39.2 ppb to about 8.2 ppb at pH 3. In some embodiments, EDTA can reduce the level of Hg by equal to or at least about 70% or about 80% at pH 3.

As shown in FIG. 2B, in some embodiments, a water wash at a temperature of at least about 70° C. can reduce the level of As from about 101 ppb to about 10 ppb at pH 3. In some embodiments, water can reduce the level of As from about 134 ppb to about 10 ppb at pH 3. In some embodiments, water can reduce the level of As by equal to or at least about 90% or about 95% at pH 3. In some embodiments, water can reduce the level of Cd from about 1199 ppb to about 10 ppb at pH 3. In some embodiments, water can reduce the level of Cd from about 1592 ppb to about 10 ppb at pH 3. In some embodiments, water can reduce the level of Cd by equal to or at least about 98% or about 99% at pH 3. In some embodiments, water can reduce the level of Pb from about 310 ppb to about 83 ppb at pH 3. In some embodiments, water can reduce the level of Pb from about 412 ppb to about 85 ppb at pH 3. In some embodiments, the water can reduce the level of Pb by equal to or at least about 70% or about 75% at pH 3. In some embodiments, water can reduce the level of Hg from about 29.5 ppb to about 7.5 ppb at pH 3. In some embodiments, the peptide chelator can reduce the level of Hg from about 39.2 ppb to about 7.7 ppb at pH 3. In some embodiments, the peptide chelator can reduce the level of Hg by equal to or at least about 70% or about 80% at pH 3.

The pH 3.0 condition conclusions: All chelants provided nearly the same removal level for all HMs tested; between 85-95% of the HM content was removed from the protein sample; the lead remained in the highest concentration which was about the same for all chelants as well; there was a significant drop in the cadmium removal for the EDTA chelant; for total HM removal hot water @ pH 3.0 is a good technique for removing the heavy metals.

FIG. 2C shows the reduction of heavy metal at pH 6. As shown in FIG. 2C, in some embodiments, the peptide chelator can reduce the level of As from about 101 ppb to about 23 ppb at pH 6. In some embodiments, the peptide chelator can reduce the level of As from about 134 ppb to about 23 ppb at pH 6. In some embodiments, the peptide chelator can reduce the level of As by equal to or at least about 85% or about 90% at pH 6. In some embodiments, the peptide chelator can reduce the level of Cd from about 1199 ppb to about 216 ppb at pH 6. In some embodiments, the peptide chelator can reduce the level of Cd from about 1592 ppb to about 196 ppb at pH 6. In some embodiments, the peptide chelator can reduce the level of Cd by equal to or at least about 80% or about 85% at pH 6. In some embodiments, the peptide chelator can reduce the level of Pb from about 310 ppb to about 78 ppb at pH 6. In some embodiments, the peptide chelator can reduce the level of Pb from about 412 ppb to about 71 ppb at pH 6. In some embodiments, the peptide chelator can reduce the level of Pb by equal to or at least about 80% or about 85% at pH 6. In some embodiments, the peptide chelator can reduce the level of Hg from about 29.5 ppb to about 8.9 ppb at pH 6. In some embodiments, the peptide chelator can reduce the level of Hg from about 39.2 ppb to about 8.1 ppb at pH 6. In some embodiments, the peptide chelator can reduce the level of Hg by equal to or at least about 70% or about 80% at pH 6.

As shown in FIG. 2C, in some embodiments, citric acid can reduce the level of As from about 101 ppb to about 18 ppb at pH 6. In some embodiments, citric acid can reduce the level of As from about 134 ppb to about 16 ppb at pH 6. In some embodiments, citric acid can reduce the level of As by equal to or at least about 80% or about 90% at pH 6. In some embodiments, citric acid can reduce the level of Cd from about 1199 ppb to about 194 ppb at pH 6. In some embodiments, citric acid can reduce the level of Cd from about 1592 ppb to about 171 ppb at pH 6. In some embodiments, citric acid can reduce the level of Cd by equal to or at least about 80% or about 85% at pH 6. In some embodiments, citric acid can reduce the level of Pb from about 310 ppb to about 75 ppb at pH 6. In some embodiments, citric acid can reduce the level of Pb from about 412 ppb to about 66 ppb at pH 6. In some embodiments, citric acid can reduce the level of Pb by equal to or at least about 75% or about 83% at pH 6. In some embodiments, citric acid can reduce the level of Hg from about 29.5 ppb to about 9.3 ppb at pH 6. In some embodiments, citric acid can reduce the level of Hg from about 39.2 ppb to about 8.2 ppb at pH 6. In some embodiments, citric acid can reduce the level of Hg by equal to or at least about 70% or about 80% at pH 6.

As shown in FIG. 2C, in some embodiments, EDTA can reduce the level of As from about 101 ppb to about 18 ppb at pH 6. In some embodiments, EDTA can reduce the level of As from about 134 ppb to about 17 ppb at pH 6. In some embodiments, EDTA can reduce the level of As by equal to or at least about 85% or about 90% at pH 6. In some embodiments, EDTA can reduce the level of Cd from about 1199 ppb to about 57 ppb at pH 6. In some embodiments, EDTA can reduce the level of Cd from about 1592 ppb to about 53 ppb at pH 6. In some embodiments, EDTA can reduce the level of Cd by equal to or at least about 95% or about 97% at pH 6. In some embodiments, EDTA can reduce the level of Pb from about 310 ppb to about 31 ppb at pH 6. In some embodiments, EDTA can reduce the level of Pb from about 412 ppb to about 27 ppb at pH 6. In some embodiments, EDTA can reduce the level of Pb by equal to or at least about 85% or about 95% at pH 6. In some embodiments, EDTA can reduce the level of Hg from about 29.5 ppb to about 9.2 ppb at pH 6. In some embodiments, EDTA can reduce the level of Hg from about 39.2 ppb to about 8.5 ppb at pH 6. In some embodiments, EDTA can reduce the level of Hg by equal to or at least about 70% or about 80% at pH 6.

As shown in FIG. 2C, in some embodiments, a water wash at a temperature of at least about 70° C. can reduce the level of As from about 101 ppb to about 11 ppb at pH 6. In some embodiments, water can reduce the level of As from about 134 ppb to about 12 ppb at pH 6. In some embodiments, water can reduce the level of As by equal to or at least about 90% or about 95% at pH 6. In some embodiments, water can reduce the level of Cd from about 1199 ppb to about 299 ppb at pH 6. In some embodiments, water can reduce the level of Cd from about 1592 ppb to about 313 ppb at pH 6. In some embodiments, water can reduce the level of Cd by equal to or at least about 75% or about 80% at pH 6. In some embodiments, water can reduce the level of Pb from about 310 ppb to about 83 ppb at pH 6. In some embodiments, water can reduce the level of Pb from about 412 ppb to about 87 ppb at pH 6. In some embodiments, the water can reduce the level of Pb by equal to or at least about 70% or about 75% at pH 6. In some embodiments, water can reduce the level of Hg from about 29.5 ppb to about 7.9 ppb at pH 6. In some embodiments, the peptide chelator can reduce the level of Hg from about 39.2 ppb to about 8.3 ppb at pH 6. In some embodiments, the peptide chelator can reduce the level of Hg by equal to or at least about 70% or about 80% at pH 6.

Results at pH 6.0 showed that arsenic was reduced the most by EDTA. Arsenic and mercury were removed to about the same levels with all chelants. Cadmium, and to a lesser degree lead, was removed most efficiently by the EDTA at this pH condition.

FIG. 2D shows the reduction of heavy metal at pH 9. As shown in FIG. 2D, in some embodiments, the peptide chelator can reduce the level of As from about 101 ppb to about 23 ppb at pH 9. In some embodiments, the peptide chelator can reduce the level of As from about 134 ppb to about 24 ppb at pH 9. In some embodiments, the peptide chelator can reduce the level of As by equal to or at least about 85% or about 90% at pH 9. In some embodiments, the peptide chelator can reduce the level of Cd from about 1199 ppb to about 379 ppb at pH 9. In some embodiments, the peptide chelator can reduce the level of Cd from about 1592 ppb to about 349 ppb at pH 9. In some embodiments, the peptide chelator can reduce the level of Cd by equal to or at least about 70% or about 75% at pH 9. In some embodiments, the peptide chelator can reduce the level of Pb from about 310 ppb to about 87 ppb at pH 9. In some embodiments, the peptide chelator can reduce the level of Pb from about 412 ppb to about 80 ppb at pH 9. In some embodiments, the peptide chelator can reduce the level of Pb by equal to or at least about 70% or about 80% at pH 9. In some embodiments, the peptide chelator can reduce the level of Hg from about 29.5 ppb to about 9.1 ppb at pH 9. In some embodiments, the peptide chelator can reduce the level of Hg from about 39.2 ppb to about 8.4 ppb at pH 9. In some embodiments, the peptide chelator can reduce the level of Hg by equal to or at least about 70% or about 80% at pH 9.

As shown in FIG. 2D, in some embodiments, citric acid can reduce the level of As from about 101 ppb to about 14 ppb at pH 9. In some embodiments, citric acid can reduce the level of As from about 134 ppb to about 13 ppb at pH 9. In some embodiments, citric acid can reduce the level of As by equal to or at least about 85% or about 90% at pH 9. In some embodiments, citric acid can reduce the level of Cd from about 1199 ppb to about 269 ppb at pH 9. In some embodiments, citric acid can reduce the level of Cd from about 1592 ppb to about 252 ppb at pH 9. In some embodiments, citric acid can reduce the level of Cd by equal to or at least about 75% or about 85% at pH 9. In some embodiments, citric acid can reduce the level of Pb from about 310 ppb to about 60 ppb at pH 9. In some embodiments, citric acid can reduce the level of Pb from about 412 ppb to about 56 ppb at pH 9. In some embodiments, citric acid can reduce the level of Pb by equal to or at least about 80% or about 85% at pH 9. In some embodiments, citric acid can reduce the level of Hg from about 29.5 ppb to about 8.7 ppb at pH 9. In some embodiments, citric acid can reduce the level of Hg from about 39.2 ppb to about 8.2 ppb at pH 9. In some embodiments, citric acid can reduce the level of Hg by equal to or at least about 70 or about 80% at pH 9.

As shown in FIG. 2D, in some embodiments, EDTA can reduce the level of As from about 101 ppb to about 20 ppb at pH 9. In some embodiments, EDTA can reduce the level of As from about 134 ppb to about 20 ppb at pH 9. In some embodiments, EDTA can reduce the level of As by equal to or at least about 80% or about 90% at pH 9. In some embodiments, EDTA can reduce the level of Cd from about 1199 ppb to about 76 ppb at pH 9. In some embodiments, EDTA can reduce the level of Cd from about 1592 ppb to about 76 ppb at pH 9. In some embodiments, EDTA can reduce the level of Cd by equal to or at least about 90% or about 95% at pH 9. In some embodiments, EDTA can reduce the level of Pb from about 310 ppb to about 40 ppb at pH 9. In some embodiments, EDTA can reduce the level of Pb from about 412 ppb to about 40 ppb at pH 9. In some embodiments, EDTA can reduce the level of Pb by equal to or at least about 85% or about 90% at pH 9. In some embodiments, EDTA can reduce the level of Hg from about 29.5 ppb to about 8.9 ppb at pH 9. In some embodiments, EDTA can reduce the level of Hg from about 39.2 ppb to about 8.8 ppb at pH 9. In some embodiments, EDTA can reduce the level of Hg by equal to or at least about 70% or about 80% at pH 9.

As shown in FIG. 2D, in some embodiments, a water wash at a temperature of at least about 70° C. can reduce the level of As from about 101 ppb to about 15 ppb at pH 9. In some embodiments, water can reduce the level of As from about 134 ppb to about 15 ppb at pH 9. In some embodiments, water can reduce the level of As by equal to or at least about 85% or about 90% at pH 9. In some embodiments, water can reduce the level of Cd from about 1199 ppb to about 366 ppb at pH 9. In some embodiments, water can reduce the level of Cd from about 1592 ppb to about 374 ppb at pH 9. In some embodiments, water can reduce the level of Cd by equal to or at least about 70% or about 80% at pH 9. In some embodiments, water can reduce the level of Pb from about 310 ppb to about 74 ppb at pH 9. In some embodiments, water can reduce the level of Pb from about 412 ppb to about 76 ppb at pH 9. In some embodiments, the water can reduce the level of Pb by equal to or at least about 75% or about 80% at pH 9. In some embodiments, water can reduce the level of Hg from about 29.5 ppb to about 7.9 ppb at pH 9. In some embodiments, the peptide chelator can reduce the level of Hg from about 39.2 ppb to about 8.1 ppb at pH 9. In some embodiments, the peptide chelator can reduce the level of Hg by equal to or at least about 70% or about 80% at pH 9.

FIGS. 2E-2H show the acceptable metal levels as a dashed line. As shown in FIGS. 2E-2H, the heavy metal levels were reduced to acceptable levels for nearly all metals and for nearly all chelators and wash procedures. As shown in FIGS. 2A-2H, changing extraction pH made an impact on the removal efficiency and the most effective pH is not the same for all HM elements tested or all chelators.

As shown in FIG. 2E, arsenic is removed at the lower pH 3.0 by all chelating agents. All chelants and conditions achieved levels significantly below the minimum needed. As shown in FIG. 2F, at pH 3.0 water, citric acid, and peptide were effective. Cadmium was removed efficiently at pH 6.0 with EDTA. Each test produced product below target minimum level. Water, citric acid and peptide were effective at pH 3.0. EDTA worked at the pH 6 and 9 levels but not as good as water, citric acid and peptide at the lower pH range. As shown in FIG. 2G, EDTA removed lead at least as well as the other chelants and was most efficient at pH was 6.0. All chelants and conditions achieved levels below the minimum metal levels. As shown in FIG. 2H, mercury was removed by low pH water followed by citric acid. EDTA was the least effective especially at the more alkaline conditions. You can see below the target minimum level we need to achieve for mercury content in the product. All chelants and conditions achieved levels below the minimum metal levels.

FIGS. 2I-2L show the data for the adjusted heavy metals from Table 2.

The lab tests show that the protein and heavy metal entities can be separated by using decanting centrifuges. Microfiltration (“MF”) and/or ultrafiltration (“UF”) membranes may be used instead of centrifuges. Large scale test work showed that centrifuges and decanters can be utilized to separate the rice protein isolate from the mixture and the resulting rice protein isolate cake separated out can be re-suspended in hot water and separated again with either the decanter or a centrifuge. The amount of wash water required to wash the chelant along with the chelated heavy metals, fat, ash, peptides, and amino acids from the rice protein isolate varied between a range of 4× to 10× of the starting mass of the heavy metal contaminated plant protein mixture.

Test work showed that in addition to centrifuges and decanters other separation technologies could be successfully applied to separate the protein isolate from the low molecular weight carbohydrate fractions, ash, fat, peptide fragments, and amino acids. The technologies that can also be employed in addition to decanters and centrifuges to perform the rice protein isolate separation from the chelant and the chelated heavy metals are described as follows. Microfiltration (MF) and Ultrafiltration (UF) crossflow membrane technology can be utilized along with very selective pore size membranes to get very precise separations from the protein isolate. UF Membrane with molecular retention ranging from 1,000 Dalton to 800,000 Daltons will allow the diafiltration (washing) of the chelants out of the rice protein mixture with elevated temperature water through the membrane while retaining the rice protein mixture allowing the desired separation of the chelant containing the chelated heavy metals from the heavy metal reduced protein isolate. Testing demonstrated the amount of diafiltration water required to effectively wash out the chelant and the heavy metals varied between a range of 4× to 10× of the starting mass of the heavy metal contaminated protein mixture. Due to the very highly controlled pore size of the membranes high yields of protein isolate can be achieved from the application of this technology.

Filter presses of various designs can be used to filter the rice protein isolate from the mixture and then the resulting cake can be washed in situ with various amounts of elevated temperature water to again wash the chelant and the chelated heavy metals from the rice protein isolate mixture. Wash volumes again can range between 2× and 10× of the starting mass of the heavy metal contaminated protein mixture. Protein yields can be somewhat lower with this technology as some of the protein can pass through the filter media used.

Rotary vacuum filter drums can be used to filter the rice protein isolate from the mixture and then the resulting cake can be washed either in situ or the rice protein cake can be re-suspended and re-filtered with various amounts of hot water to again wash the chelant and the chelated heavy metals from the rice protein isolate mixture. Wash volumes again can range between 2× and 10× of the starting mass of the heavy metal contaminated protein mixture. As with the filter press technology rotary vacuum filter drums have been used and have been shown to provide protein yields somewhat lower than with the membrane technologies.

It is noted that these protocols could be used for reducing the HM in products during manufacturing and/or to remediate the HM content in previously produced protein products.

### Example 3

### Introduction and Objectives

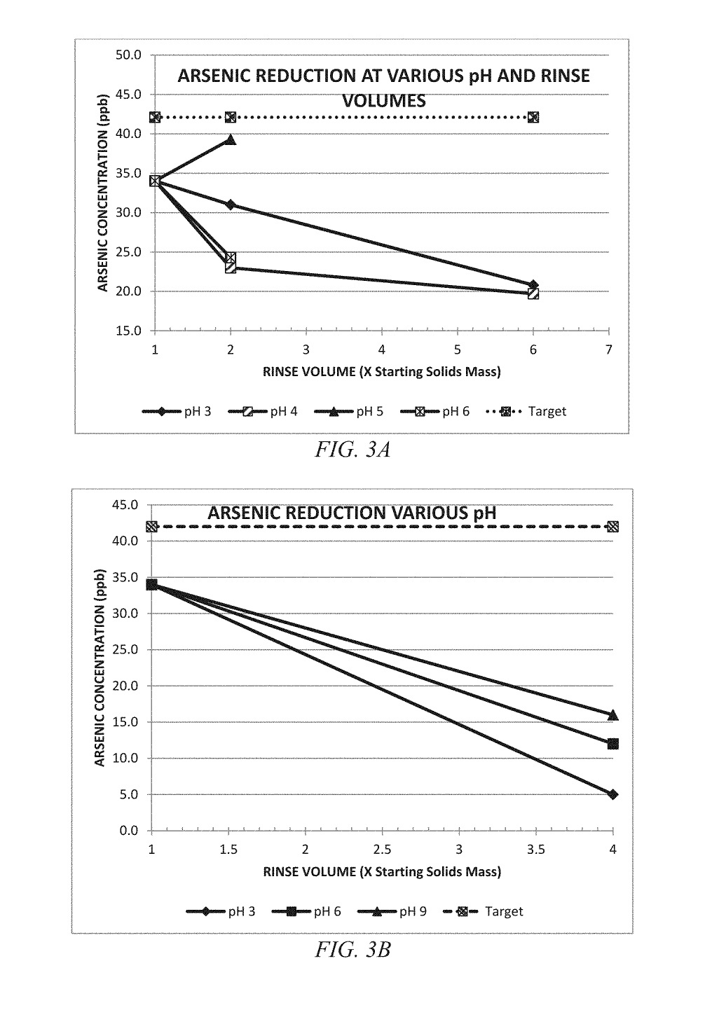

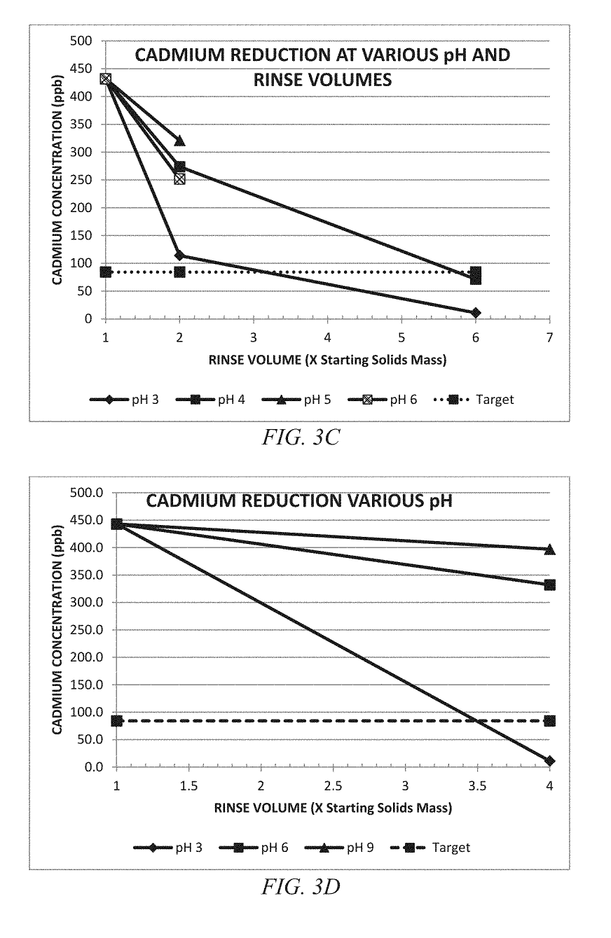

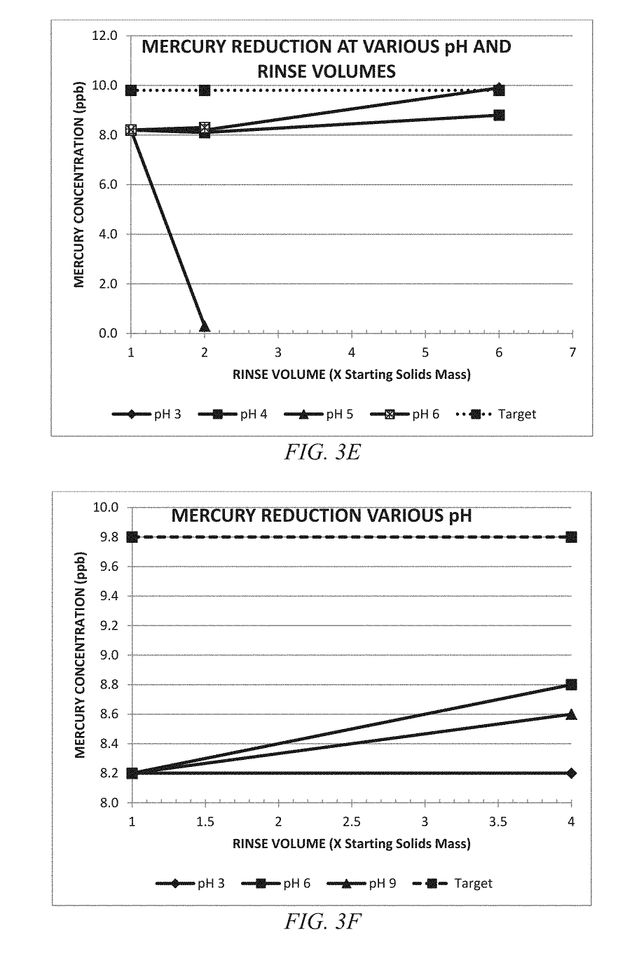

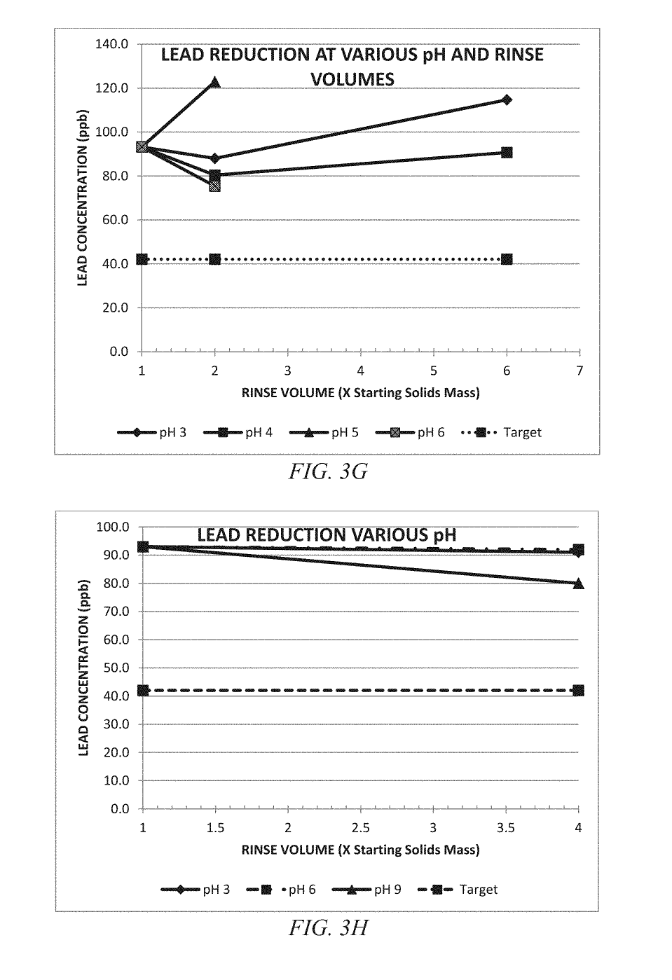

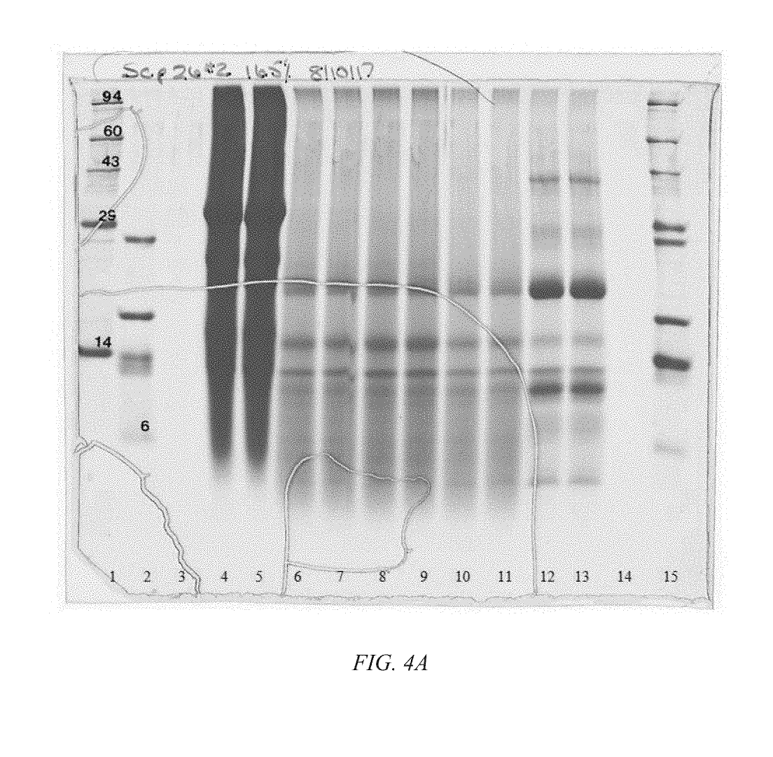

A rice protein sample with heavy metal contamination was used to perform the following heavy metal remediation tests. This testing was used to demonstrate that, using the procedures disclosed herein, in some embodiments, some heavy metals may be removed using washing methods without chelating agents. Briefly, a fixed quantity of powdered protein was added to a fixed amount of pH adjusted DI water. The protein isolate water mixture was adjusted to pH values of 3, 4, 5, or 6 as shown in FIGS. 3A-3H. The pH was adjusted using a dilute 10% by weight concentrated 38% HCl solution and by measuring the pH using a temperature correcting pH meter. After the pH was adjusted, the mixtures were agitated for 5 minutes at about 70° C. The solutions were then allowed to sit for 15-20 minutes in a temperature controlled hot water bath at 70° C. The protein isolate mixture was then centrifuged at 9000 RPM for 3 minutes. The supernatant was then extracted. Depending on the wash method, as shown in FIGS. 3A-3H, the dilution and concentration procedure could be repeated. Starting samples, 2× wash samples, 4× wash samples and 6× wash samples were submitted for analysis targeting heavy metal arsenic (Ar), cadmium (Cd), mercury (Hg), and lead (Pb).

### Data:

Attached as FIGS. 3A-3H are the graphs showing the data and washes performed. As can be seen in some of the analytical results, in some instances metal levels increased. Without being bound to a particular theory, this may be due to the dissolution and removal of some of the peptide/protein product with the soluble fraction during decanting without dissolution removal of the same quantity of heavy metal.

Tables 3 and 4 contain raw data with analytical result obtained from the disclosed test procedures.

TABLE 3

| | | | ANALYTICAL (ppb) | | | | |
|---|---|---|---|---|---|---|---|
| SAMPLE DESCRIPTION | WASH | pH | % TS | Ar | Cd | Hg | Pb |
| Target Maximum HM Levels (dry solids) | 0X | 5.9 | 95.0 | 125 | 250 | 29 | 125 |
| Target Max HM Levels (adjusted) | 0X | 5.9 | 32.0 | 42.1 | 84.2 | 9.8 | 42.1 |
| Target Max HM Levels (adjusted) | 0X | 5.9 | 3.5 | 4.6 | 9.2 | 11 | 4.6 |
| Feedstock HM Levels (C of A source) | 0X | 5.9 | 95.0 | 114 | 1418 | 25 | 240 |
| Feedstock HM Levels (Analytical test 1) | 0X | 5.9 | 95.0 | 101 | 1199 | 24.5 | 310 |
| Feedstock HM Levels (Analytical test 2) | 0X | 5.9 | 95.0 | 88 | 1330 | 23.4 | 280 |
| Feedstock HM Levels (Ave. Analytical tests) | 0X | 5.9 | 95.0 | 101 | 1316 | 24.3 | 277 |
| Feedstock HM Levels (adjusted 32% solids) | 0X | 5.9 | 32.0 | 34 | 443 | 8.2 | 93 |
| Feedstock HM Levels (adjusted 3.5% solids) | 0X | 5.9 | 3.5 | 3.7 | 48.5 | 0.9 | 10.2 |
| Decanted Test Sample | 2X | 3 | 32.0 | 31.0 | 114 | 8.2 | 88.0 |
| Decanted Test Sample | 6X | 3 | 29.3 | 19.0 | 10.0 | 9.0 | 105 |
| Decanted Test Sample (solids adjusted 32%) | 6X | 3 | 32.0 | 20.8 | 10.9 | 9.9 | 115 |
| Decanted Test Sample | 2X | 4 | 37.4 | 23.0 | 320 | 9.5 | 94.0 |
| Decanted Test Sample (solids adjusted 32%) | 2X | 4 | 32.0 | 19.7 | 274 | 8.1 | 80.4 |
| Decanted Test Sample | 6X | 4 | 36.7 | 22.0 | 82.0 | 10.1 | 104 |
| Decanted Test Sample(solids adjusted 32%) | 6X | 4 | 32.0 | 19.2 | 71.5 | 8.8 | 90.7 |
| Decanted Test Sample | 2X | 5 | 375 | 46.0 | 376 | 0.3 | 144 |
| Decanted Test Sample(solids adjusted 32%) | 2X | 5 | 32.0 | 39.3 | 321 | 0.3 | 123 |
| Decanted Test Sample | 2X | 6 | 36.9 | 28.0 | 290 | 9.5 | 87.0 |
| Decanted Test Sample(solids adjusted 32%) | 2X | 6 | 32.0 | 24.3 | 252 | 8.3 | 75.4 |

TABLE 4

| | WASH | pH | ANALYTICAL (ppb) | | | | |
|---|---|---|---|---|---|---|---|
| SAMPLE DESCRIPTION | LEVEL | TEST | % TS | Ar | Cd | Hg | Pb |
| Target Maximum HM Levels (dry solids) | 0X | 5.9 | 95.0 | 125 | 250 | 29 | 125 |
| Target Max HM Levels (adjusted) | 0X | 5.9 | 32.0 | 42.1 | 84.2 | 9.8 | 42.1 |
| Feedstock HM Levels (C of A source) | 0X | 5.9 | 95.0 | 114 | 1418 | 25 | 240 |
| Feedstock HM Levels (Analytical test 1) | 0X | 5.9 | 95.0 | 101 | 1199 | 24.5 | 310 |
| Feedstock HM Levels (Analytical test 2) | 0X | 5.9 | 95.0 | 88 | 1330 | 23.4 | 280 |
| Feedstock HM Levels (Ave. Analytical tests) | 0X | 5.9 | 95.0 | 101 | 1316 | 24.3 | 277 |
| Feedstock HM Levels (adjusted 32% solids) | 0X | 5.9 | 32.0 | 34 | 443 | 8.2 | 93 |
| Decanted Test Sample | 4X | 3.0 | 29.25 | <10 | 10 | 7.5 | 83 |
| Decanted Test Sample (adjusted 32% solids) | 4X | 3.0 | 32.0 | | 10.9 | 8.2 | 90.8 |
| Decanted Test Sample | 4X | 6.0 | 28.78 | 11 | 299 | 7.9 | 83 |
| Decanted Test Sample (adjusted 32% solids) | 4X | 6.0 | 32.0 | 12.2 | 332 | 8.8 | 92 |
| Decanted Test Sample | 4X | 9.0 | 29.49 | 15 | 366 | 7.9 | 74 |
| Decanted Test Sample (adjusted 32% solids) | 4X | 9.0 | 32.0 | 16.3 | 397 | 8.6 | 80 |

### Results:

### Arsenic (Ar):

The results for the arsenic heavy metal reduction using water are shown in FIGS. 3A-3B. The trial indicated that pH 3 and 4 were the target pH levels for treatment and further removal of arsenic. After 2× wash the pH 5 sample was higher in arsenic than the feed. Acid washes at various pH levels were able to reduce arsenic levels.

### Cadmium (Cd):

The result for cadmium heavy metal remediation work is shown in FIGS. 3C-3D. The starting sample protein had significant levels of cadmium that were above the maximum allowed target level. Cadmium levels were reduced with all washes and the more acidic pH 3 wash provided the greatest reduction. After the 3× wash at pH 3, the sample was under the target specification for cadmium. Cadmium was also reduced with pH 4 solution but required additional rinse volumes than the pH 3 solution.

### Mercury (Hg):

The result for mercury heavy metal remediation work is shown in FIGS. 3E-3F. In almost every sample there was more Hg at the end of the test rinses than at the start The pH 5 sample showed a significant reduction.

### Lead (Pb):

The result for lead heavy metal remediation work is shown in FIGS. 3G-3H. The lead analysis showed again more lead in the 6× wash than the starting material. The pH 5 wash immediately showed more lead than the starting material while at 2× wash the other pH levels showed ˜10-20% reduction in lead content of the centrifuged protein mass. None of the samples were shown to reduce the lead below the target maximum level.

### Test Observations:

It was noted that more acidic rinses removed more heavy metal from the protein for arsenic and cadmium. Both cadmium and arsenic levels were reduced below the maximum allowed food standards levels with the low pH treatment. Little impact was observed on the mercury but starting mercury levels were below the maximum target allowed so all samples passed the mercury content standard. None of the pH levels and wash levels for which data was available reduced the lead below maximum standards. This results with lead may be due to lead having amphoterism, meaning it is reactive and soluble at both high and low pH ranges.

### Example 4

### Synthesis and Characterization of a Peptide Chelator

Rice-based peptide chelators were prepared by the following procedures. 100 g of Silk-80 (AXIOM protein product: Moisture: 2.7%; Protein 81%; Fat 1.2%; Ash <4.5%, Fiber: <10%, Carbohydrate <13.3%) was placed into agitator and agitated with 233 g of hot 50° C. RO/DI water producing 300 g of solution (˜30% total solids). To this solution was added 3.6 g (300 ppm) CaCl₂. To this solution was added 10% NaOH to bring pH to 8.5 (+/−0.1). To this mixture was added Alcalase® (an alkaline protease enzyme) at 2% by weight of the protein dry weight. The solution was agitated at 50° C. for 2 hours at which time an aliquot was removed and quenched (using procedures described below) to produce a first peptide chelator sample (K-1). The solution was agitated at 50° C. for an additional 2 hours (4 hours total) at which time a second aliquot was removed and quenched (using procedures described below) to produce a second peptide chelator sample (K-2). The solution was agitated at 50° C. for an additional 2 hours (6 hours total) at which time the solution was quenched (using procedures described below) to produce a third peptide chelator sample (K-3).

To perform the quench, the mixture was heated to 80-85° C. and held for 10 minutes to deactivate the enzyme. After 10-minute hold time the mixture was cooled to 50° C., the mixture was then centrifuged causing the solids to separate via G-forces from the peptide solution. The supernatant containing the peptide chelators was decanted and the weight of total solids was measured. The supernatant was collected for use as a chelator. A dilute solution of peptides was obtained from this enzyme hydrolysis of rice protein. This product was filtered and stored for use during chelation experiments.

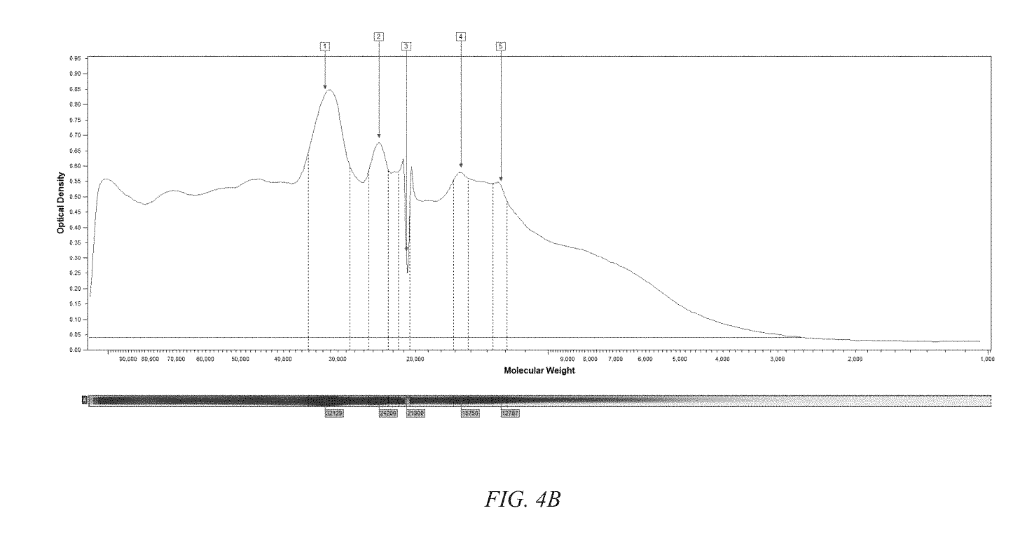

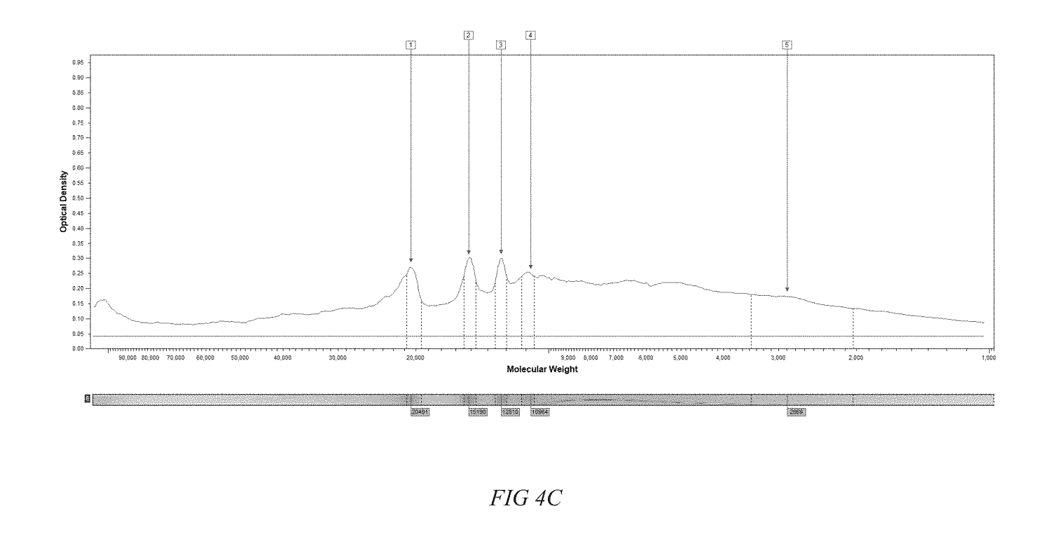

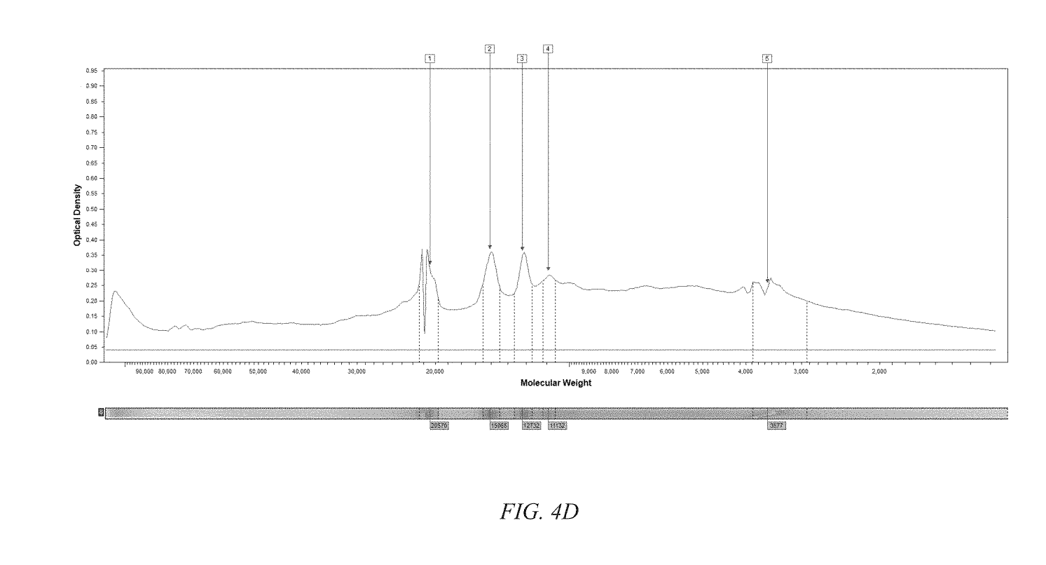

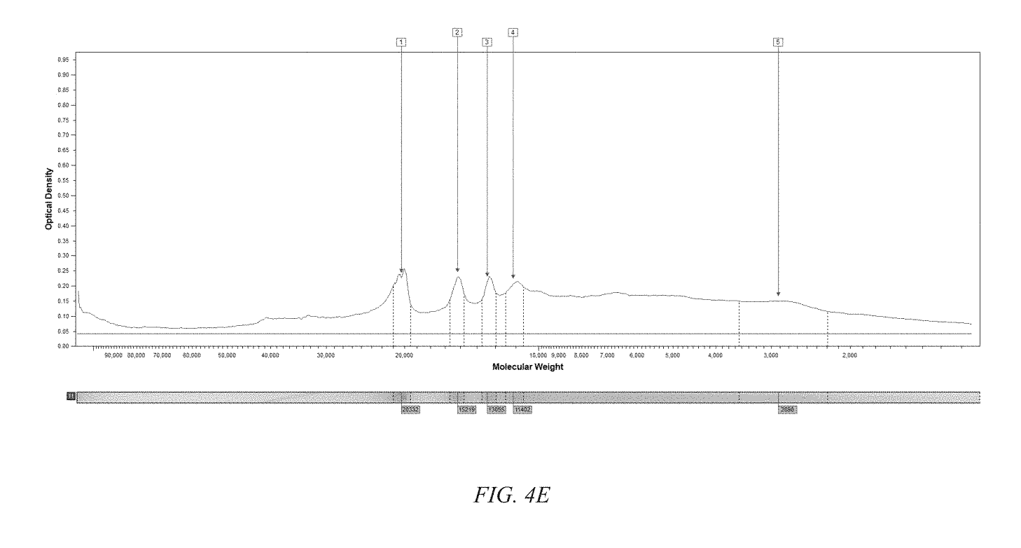

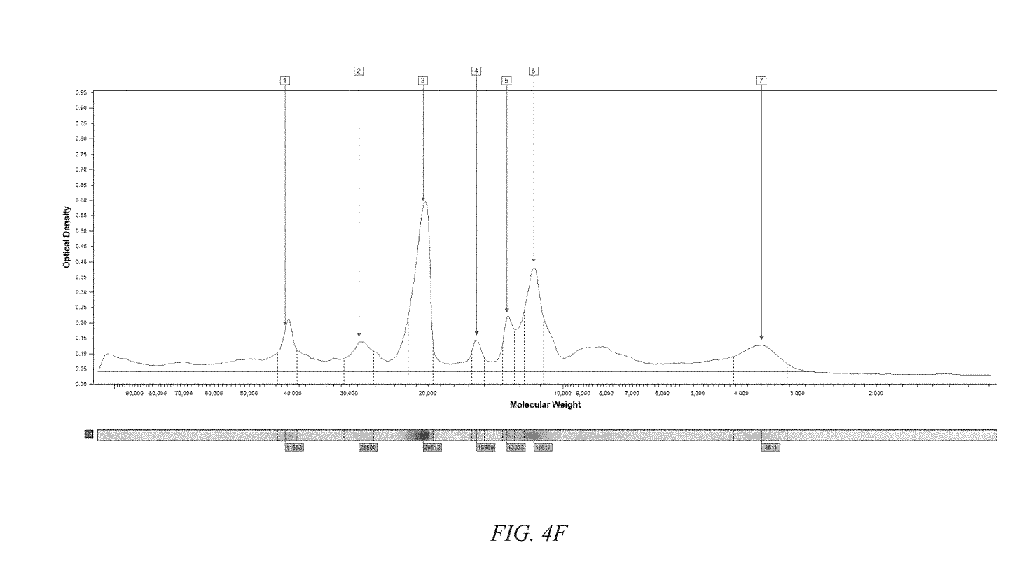

FIG. 4A shows the results of a polyacrylamide gel electrophoresis (“PAGE”) peptide separation. The PAGE analysis uses the property that proteins and peptides migrate at varying rates through a polyacrylamide gel when an electric field is applied across the gel depending on the unique amount of charge and molecular weight of the protein and peptide entities. The difference in charge is caused by the different charged functional groups a particular protein may have. The PAGE analysis was performed by Kendrick Laboratories, Inc., an independent analytical lab located at 1202 Ann St., Madison, Wis. 53713 (800-462-3417). The methods used in preparation of this PAGE are as follows:

The samples were weighed, dissolved in SDS Sample Buffer without reducing agents, and heated in a boiling water bath for 5 minutes. The samples were cooled, briefly centrifuged, and the protein concentration of the supernatant was then determined using the BCA Assay (Smith et. al. Anal. Biochem. 150: 76-85, 1985, and Pierce Chemical Co., Rockford, Ill.). Following the BCA, the samples were prepared in sample buffer with reducing agents containing 2.3% sodium dodecyl sulfate (SDS), 10% glycerol, 50 mM dithiothreitol, and 63 mM tris, pH 6.8. Following buffer addition, the samples were heated in a boiling water bath for 5 minutes. The samples were briefly centrifuged and the supernatant was loaded on the gel.

SDS slab gel electrophoresis was carried out using 16.5% acrylamide peptide slab gels (Shagger, H. and Jagow, G. Anal. Biochem. 166:368, 1987) (0.75 mm thick). SDS slab gel electrophoresis was started at 15 mAmp/gel for the first four hours and then carried out overnight at 12 mAmp/gel as for the separation of peptides. The slab gels were stopped once the bromophenol blue front had migrated to the end of the slab gel. Following slab gel completion, the gels were stained with Coomassie blue dye, destained in 10% acetic acid until a clear background was obtained, and dried between cellophane sheets.

The following proteins (Sigma Chemical Co., St. Louis, Mo. and EMD Millipore, Billerica, Mass.) were added as molecular weight standards: phosphorylase A (94,000), catalase (60,000), actin (43,000), carbonic anhydrase (29,000), lysozyme (14,000), myoglobin (I+III, 56-153) (10,600), Myoglobin (1, 56-131)(8,160), mryoglobin (II 1-55)(6,210), glucagon (3,480), and myoglobin (III, 132-153)(2,510).

The stained gels were digitized over the appropriate optical density range using a calibrated GE Healthcare Image Scanner III. Molecular weights were calculated from the molecular weight standards using Phoretix 1D software (version 11.2) with a Windows 7 compatible computer and a first order lagrange molecular weight curve.

The PAGE work was done with protein and peptide standards of well characterized molecular weight to compare the molecular weights of the supplied peptide samples for analysis. A photo copy of the actual gel plate image with tracks in duplicate is shown on FIG. 4A. Table 5 shows the track (lane) number and sample that is on the respective track. Table 6 shows the total protein results as a percentage of sample weight. This table provides details regarding the relative protein concentration of samples that were subjected to the PAGE procedure. The relative protein concentrations used in the PAGE protocol varied from 459 to 1109 μg/L between the various protein/peptide fractions tested. As can be seen the raw material lot had the highest % of protein. This may account for why tracks 4 and 5 are darker than the other tracks. A more dilute solution would have reduced the optical density of those two tracks. However, a samples were within a range whereby good comparison of peaks was possible. The protein concentrations were measured against a protein standard using the BCA analytical protocol as stated above. BCA utilizes a protein binding dye and UV absorption technology to determine the protein concentrations for each track. 50 μg of each protein sample was placed on each track for PAGE development.

TABLE 5
Key to Loading Gel SC p. 26 #2.

| | | μg | μg |
|---|---|---|---|
| Lane | Sample | Protein | Sample |
| 1 | High Range Molecular Weight Standards | — | — |
| 2 | Low Range Molecular Weight Standards | — | — |
| 3 | Sample Buffer Blank | — | — |
| 4 | K-5: Raw material lot# HZN16003E | 50 | 1109 |
| 5 | K-5: Raw material lot# HZN16003E | 50 | 1109 |
| 6 | K-1: Enzyme 2 hr hold | 50 | 597 |
| 7 | K-l: Enzyme 2 hr hold | 50 | 597 |
| 8 | K-2: Enzye 4 hr hold | 50 | 518 |
| 9 | K-2: Enzye 4 hr hold | 50 | 518 |
| 10 | K-3: Enzyme 6 hr hold | 50 | 459 |
| 11 | K-3: Enzyme 6 hr hold | 50 | 459 |
| 12 | I-F: Filtered lot# WRP34316 | 50 | 729 |
| 13 | I-F: Filtered lot# WRP34316 | 50 | 729 |
| 14 | — | — | — |
| 15 | High and Low Range Molecular Weight | — | — |
| | Standards | | |

TABLE 6
Total protein results as a percentage of sample weight.

| | Protein as a percentage |
|---|---|
| Sample | of sample weight |
| K-1: Enzyme 2 hr hold | 8.4% |
| K-2: Enzye 4 hr hold | 9.7% |
| K-3: Enzyme 6 hr hold | 10.9% |
| K-5: Raw material lot# HZN16003E | 4.5% |
| I-F: Filtered lot# WRP34316 | 6.9% |

The known standards are on the far left of FIG. 4A with select high molecular weight standards in track 1 and select low molecular weight standards in track 2. The buffer standard was run in track 3 and showed on bands or peaks indicating that the buffer carrier did not interfere with the protein/peptide stains in the other PAGE tracks. The starting protein material is shown in the heavy blue tracks in duplicate next to the standards in tracks 4 and 5 to provide a comparison of before and after the protease activity. The next tracks show the peptide fractions in duplicate which were held at 2 hours (tracks 6 & 7), 4 hours (tracks 8 & 9), and 6 hours (tracks 10 & 11) exposure time of protease enzyme activity until the protease enzyme was deactivated with 85° C. heat for 10 minutes. A second run at 2 hours of protease enzyme exposure time was performed and this sample was filtered through a paper filter. The PAGE result of the filtered peptides is shown in tracks 12 and 13. The peptide solution was filtered to see if it would impact on the PAGE band development. The PAGE did appear somewhat better defined by filtering the sample. Track 15 is a combination of both the high and low molecular weight standards again for reference.

The same gel track plate is shown on the PAGE BAND IDENTIFICATION IMAGE with the tracks marked for easier identification. These tracks can be used as reference to the peaks that are shown on the optical scans that are described herein.

The gel tracks are shown again in a different way through the use of an optical scanning device to provide a more detailed look at the gel bands (FIGS. 4B-4F). One scan of each one of the respective tracks was selected and provided to better show the peptide bands (note the gel plate tore through some of the tracks on both plates so the best scan of each duplicate plate was included here to eliminate the issue and slight distortion of the tears. Note the numbers at the top of the scan figures correspond to the more enriched bands on the gel plates. The molecular weight of the peptide and protein peaks are shown in log scale at the bottom of the scan figures for reference. Briefly, FIGS. 4B-F are scans showing the molecular weight distribution of the tracks from the FIG. 4A PAGE gel plate. FIG. 4B is Lane 4 Sample: K-5 Raw Material Lot#HZN16003E. FIG. 4C is Lane 6 Sample: K-1 Enzyme 2 hr hold. FIG. 4D is Lane 8 Sample: K-2 Enzyme 4 hr hold. FIG. 4E is Lane 11 Sample: K-3 Enzyme 6 hr hold. FIG. 4F is Lane 13 Sample: I-F Filtered Lot# WRP34316.

FIG. 4B is the scan of the untreated feed material from track 4. It was noted that the heavy bands (e.g., shown as peaks) in the high molecular weight regions were diminished in the protease-exposed sample tracks. It was noted that the relative height of peak 1 compared to the other peaks and there was a decrease in components below molecular weight from peak 1 to almost nothing at the 3,000 molecular weight mark. FIG. 4C is the scan of track 6 for the peptide solution exposed for 2 hours to the protease enzyme. It was noted that most of the proteins above the 20,000 molecular weight band were present in reduced amounts, while the amounts of lower molecular weight peptide peaks were higher relative to the large molecular weight peaks (indicating shorter chain peptide production). It was also noted that there was new material below peak 4 with a band now at peak 5 which did not exist in the untreated feed stock material (shown in FIG. 4B). These peak shifts were indicative of peptide production. FIG. 4D is track 8 scan and showed the starting protein solution after exposure to 4 hours of protease treatment. It was noted that there was more peptide absorbance at the lower molecular weight regions with some extra low molecular weight peaks forming compared to FIGS. 4B and 4C. The height of peak 5 which was missing in FIG. 4B was almost the same height as peak 4 in FIG. 4C. FIG. 4E shows the track 11 scan after 6 hours exposure to the protease enzyme treatment. It was noted that the relative heights of the lower molecular weight peaks enriched relative to the higher molecular weight peaks. Peaks 1, 2, and 3 were of similar height as peak 4 indicating continued production of lower molecular weight peptides with time. FIG. 4F shows the track 13 with the filtered 2 hour protease exposed protease enzyme treated solution. The filtration may have removed some particulate giving a slightly more defined PAGE scan. Ultrafiltration could be used to isolate the peptide chelant, select bands preferentially, and concentrate the peptides for further use in the chelation process described herein. From this data it is expected that protein broken down into lower molecular weight peptide fragments would give more molecules to grab and hold onto heavy metal ions for removal from the rice protein isolate mixture.

The results in FIG. 4C demonstrated that the K-1 rice protein hydrolyzed product (e.g., peptide chelator) contained at least a mix of peptides ranging from about 21 kD down to about 1,000 kD and with the pronounced bands in the solution ranging from about 21 kD to about 19 kD, about 16 kD to about 14 kD, about 13 kD to about 12.5 kD, about 11.5 kD to about 10.5 kD and about 4 kD to about 2 kD. The most abundant peptides (labeled as band 1, 2, and 3 in FIG. 4C) had a molecular weight of about 20.5 kD, about 15 kD, and about 12.7 kD, as shown. The results in FIG. 4D demonstrated that the K-2 rice protein hydrolyzed product (e.g., peptide chelator) contained at least bands in the solution ranging from about 21 kD to about 19 kD, about 16 kD to about 14 kD, about 13.5 kD to about 12.5 kD, about 11.5 kD to about 10.5 kD and about 4 kD to about 2 kD. The most abundant peptides (labeled as band 1, 2, and 3 in FIG. 4D) had a molecular weight of about 20.5 kD, about 15 kD, and about 12.7 kD, as shown. The results in FIG. 4E demonstrated that the K-3 rice protein hydrolyzed product (e.g., peptide chelator) contained at least bands in the solution ranging from about 21 kD to about 19 kD, about 16 kD to about 14 kD, about 13.5 kD to about 12.5 kD, about 11.5 kD to about 10.5 kD and about 4 kD to about 2 kD. The most abundant peptides (labeled as band 1, 2, 3, and 4 in FIG. 4E) had a molecular weight of about 20.5 kD, about 15 kD, about 12.7 kD, and about 11 kD, as shown.

The above description provides context and examples, but should not be interpreted to limit the scope of the inventions covered by the claims that follow in this specification or in any other application that claims priority to this specification. No single component or collection of components is essential or indispensable. For example, some embodiments may not include a fluid modifier. Any feature, structure, component, material, step, or method that is described and/or illustrated in any embodiment in this specification can be used with or instead of any feature, structure, component, material, step, or method that is described and/or illustrated in any other embodiment in this specification.

Several illustrative embodiments have been disclosed. Although this disclosure has been described in terms of certain illustrative embodiments and uses, other embodiments and other uses, including embodiments and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various embodiments. All possible combinations and sub-combinations of elements and components described herein are intended to be included in this disclosure. No single feature or group of features is necessary or indispensable.

In summary, various embodiments and examples of chelators and methods of reducing metals have been disclosed. This disclosure extends beyond the specifically disclosed embodiments and examples to other alternative embodiments and/or other uses of the embodiments, as well as to certain modifications and equivalents thereof. Moreover, this disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims.

What is claimed is:

1. A method for preparing an organic food product with reduced heavy metal content, the method comprising:
adding an organic certified or organic certifiable chelator to an organic food product that contains a heavy metal;
allowing the chelator to bind to the heavy metal thereby forming a complex; and
separating the complex from the food product to prepare the organic food product with reduced heavy metal content.

2. The method of claim 1, wherein the organic certified or organic certifiable chelator is a peptide chelator, citric acid, or salts thereof.

3. The method of claim 1 or 2, wherein the food product is a macronutrient isolate.

4. The method of claim 3, wherein the macronutrient isolate is a carbohydrate isolate, a fat isolate, or a protein isolate.

5. The method of any one of claims 3 to 4, wherein the macronutrient is derived from a plant.

6. The method of any one of claims 1 to 5, wherein the food product is derived from white rice, brown rice, rice bran, flaxseed, coconut, pumpkin, hemp, pea, chia, lentil, fava, potato, sunflower, quinoa, amaranth, oat, wheat, or combinations thereof.

7. The method of any one of claims 1 to 6, wherein the food product is a plant protein.

8. The method of any one of claims 1 to 7, wherein the heavy metal is arsenic, cadmium, lead, mercury, or combinations thereof.

9. The method of any one of claims 1 to 8, wherein the separating step is performed by filtration through a filter.

10. The method of claim 9, wherein the complex is substantially soluble and travels through the filter.

11. The method of any one of claims 1 to 8, wherein the separating step is performed by decanting and/or centrifugation.

12. The method of any one of claims 1 to 11, wherein the chelator is a peptide chelator, wherein the peptide chelator is prepared by hydrolyzing an organic protein.

13. The method of claim 12, wherein the peptide chelator is prepared by enzymatic or chemical hydrolysis of the organic protein.

14. The method of claim 12 or 13, wherein the organic protein is derived from the same plant or animal as the food product.

15. A composition comprising a rice protein isolate comprising a heavy metal bound to an organic certified or organic certifiable chelator.

16. The composition of claim 18, wherein the organic certified or organic certifiable chelator is a peptide chelator or citric acid.

17. The composition of claim 19, wherein the peptide chelator is a rice protein hydrolysate.

18. An intermediate in the production of a nutritional supplement, the intermediate comprising a rice protein isolate comprising a heavy metal bound to an organic certified or organic certifiable chelator.

19. A method for preparing a peptide chelator, the method comprising:
enzymatically or chemically hydrolyzing an organic protein to form an organic peptide chelator; and
collecting the peptide chelator.

20. The method of claim 19, wherein the organic protein is hydrolyzed enzymatically using an enzyme.

21. The method of claim 20, wherein the enzyme comprises one or more of an acid endopeptidase, an alkaline endopeptidase, a neutral endopeptidase, pepsin, papain, carboxypeptidase, elastase, Asp-N, Glu-C, Lys-C, Arg-C, proteinase K, subtilisin, clostipain, trypsin, chymotrypsin, glutamyl endopeptidase, or thermolysin.

22. The method of claim 19, further comprising fractionating the peptide chelator from the hydrolysate.

23. A peptide chelator, comprising a protein hydrolysate comprising one or more peptides that range in molecular weight from about 2 kD to about 25 kD.

24. The peptide chelator of claim 23, wherein the one or more peptides have molecular weight ranges selected from about 21 kD to about 19 kD, about 16 kD to about 14 kD, about 13.5 kD to about 12.5 kD, about 11.5 kD to about 10.5 kD, or about 4 kD to about 2 kD.

25. The peptide chelator of claim 23, wherein the one of more peptides comprise molecular weights selected from about 20.5 kD, about 15 kD, and about 12.7 kD.

26. The peptide chelator of claim 23, wherein the one of more peptides comprise molecular weights selected from about 20.5 kD, about 15 kD, about 12.7 kD, and about 11 kD.

27. A peptide chelator made by a method comprising:
exposing a protein from a plant source to hydrolytic conditions for a period of time to prepare the protein chelator;
removing the protein chelator from the hydrolytic conditions; and
collecting the protein chelator.

28. The peptide chelator of claim 27, wherein the period of time is less than or equal to about 1 hour, about 2 hours, about 4 hours, about 6 hours, about 10 hours, or ranges including and/or spanning the aforementioned values.

29. The peptide chelator of claim 27, wherein during exposure to the hydrolytic conditions, the protein is exposed to an enzyme.

30. The peptide chelator of claim 27, wherein during collecting of the peptide chelator, the peptide chelator is filtered to collect the peptide chelator based on size and/or molecular weight.

31. The peptide chelator of claim 27, wherein the peptide chelator comprises one or more peptides having molecular weight ranges selected from about 21 kD to about 19 kD, about 16 kD to about 14 kD, about 13.5 kD to about 12.5 kD, about 11.5 kD to about 10.5 kD, and/or about 4 kD to about 2 kD.

32. The peptide chelator of claim 31, wherein the one of more peptides comprise molecular weights selected from about 20.5 kD, about 15 kD, and/or about 12.7 kD.

33. The peptide chelator of claim 31, wherein the one of more peptides comprise molecular weights selected from about 20.5 kD, about 15 kD, about 12.7 kD, and/or about 11 kD.

34. The peptide chelator of claim 27, wherein during exposure to the hydrolytic conditions, the temperature is held at a temperature within the range from 5° C. and 85° C.

35. The peptide chelator of claim 27, wherein during exposure to the hydrolytic conditions, the pH is held at a pH within the range from 2.0 to 12.0.
